(19) United States
(12) Patent Application Publication
(10) Pub. No.: US 2025/0061454 A1
(43) Pub. Date: Feb. 20, 2025

(54) APPARATUS FOR GENERATING METADATA, AN APPARATUS FOR EXAMINING METADATA AND AN APPARATUS FOR STORING METADATA

(71) Applicants: Arkadiusz BERENT, Tuchom (PL); Mateusz BRONK, Gdansk (PL); Krystian MATUSIEWICZ, Gdansk (PL); Piotr ZMIJEWSKI, Gdansk (PL)

(72) Inventors: Arkadiusz BERENT, Tuchom (PL); Mateusz BRONK, Gdansk (PL); Krystian MATUSIEWICZ, Gdansk (PL); Piotr ZMIJEWSKI, Gdansk (PL)

(21) Appl. No.: 18/921,083

(22) Filed: Oct. 21, 2024

(51) Int. Cl. G06Q 20/38

(52) U.S. Cl. CPC G06Q 20/389; G06Q 20/3827; G06Q 20/3829

(57) ABSTRACT

It is provided an apparatus comprising interface circuitry, machine-readable instructions, and processing circuitry to execute the machine-readable instructions. The machine-readable instructions include instructions obtain data from a first party. The data being configured for training of a machine learning model of a second party. The machine-readable instructions further include instructions to generate metadata corresponding to the data, the metadata comprising an identifier of the data. The machine-readable instructions further include instructions to publish the data appended with the corresponding metadata. The machine-readable instructions further include instructions to transmit the metadata for storage to a trusted third-party.

### BACKGROUND

The increasing demand on machine learning for various applications has led to a growing need for secure and efficient management of data used in training these models. In multi-party environments, where training data is shared across different entities, it is important to ensure that the training data is used in compliance with the conditions set by the training data owner, such as licensing agreements, payment terms, and usage restrictions. Unauthorized use or misuse of data can lead to significant legal and financial disputes, as well as potential risks to data integrity and confidentiality. There may be a need for an improved system that ensures compliance with usage conditions and provides verifiable proof of adherence to these requirements.

### BRIEF DESCRIPTION OF THE FIGURES

Some examples of apparatuses and/or methods will be described in the following by way of example only, and with reference to the accompanying figures, in which

FIG. 1 illustrates a block diagram of an example of a first apparatus;

FIG. 2 illustrates a block diagram of an example of a second apparatus;

FIG. 3 illustrates a block diagram of an example of a third apparatus;

FIG. 4 illustrates a block diagram of an example of a system comprising the first apparatus, the second apparatus and the third apparatus;

FIG. 5 illustrates a flowchart of an example of a first method;

FIG. 6 illustrates a flowchart of an example of a second method;

FIG. 7 illustrates a flowchart of an example of a third method;

FIG. 8 illustrates a first example of the process of publishing data by a first entity;

FIG. 9 illustrates a first example the process of obtaining published data by a second entity;

FIG. 10 illustrates a second example of the process of publishing data by a first entity; and

FIG. 11 illustrates a second example of the process of obtaining published data by a second entity.

### DETAILED DESCRIPTION

Some ‘examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

For example, machine learning model companies may train their machine learning model using data which they found on the Internet. That data may often be copyrighted material, which is used without owners' consent and/or compensation. In previous approaches either the data set author or machine learning model companies may not be satisfied. If machine learning model companies do not want to violate copyrights, they need to use data from well-known sources, but those data sets are usually limited and are not big enough to satisfy training requirements for large models. On the other hand, the Internet as whole contains massive amounts of data which could be used to train machine learning model. In addition, there are domain-specific tools which can be leveraged to protect training data from unauthorized exploitation by deep learning models. Data set authors may face the following dilemma, they can either poison and publish their data set, but that makes their work unusable for machine learning model training and they do not get any compensation. Or they can publish their work without poisoning, but it could be used without any compensation.

The disclosed technique (also referred to as data creator consent enforcement for machine learning model training) proposes a solution which satisfies both sides: machine learning model companies who want to use any data found on the Internet and data authors/owners who want to get compensation or even attribution only if their work is used by those companies. The disclosed technique may streamline the process of consent and fulfilling policies including receiving payments defined by the data set owner. Fulfilling all those policies may be done by machine learning model companies which want to legally use data sets to train a model. The described technique proposes that the company possesses well recognized proof that the data set used was paid for accordingly. This may be applied to all data set types (text, images, audio, video, etc.). This approach may not prevent unauthorized use of data set, it introduces a mechanism to prove to the data owner that the payment has been made allowing use of the data set without infringing owner's rights. Further, the proposed technique may prevent unauthorized use of data sets if appropriate payment has not been made because the trained model will be inaccurate, hence useless. This may be applied to image, video and/or audio data sets as well as text/source code data sets and the like. The proposed technique allows fixing or selectively improving quality of a data set after fulfilling policies including payments. For example, a trusted third party service may be operated acting as a proxy between the machine learning model companies and data owners. For example, the third party may provide a functionality to issue proof certificate or participate in the process of un-poisoning data sets as well as attestation of TEEs used. That may comprise handling of cryptographic material for poison data protection and facilitate use of distributed ledger for logging operations (for example, the protection may be needed to un-poison).

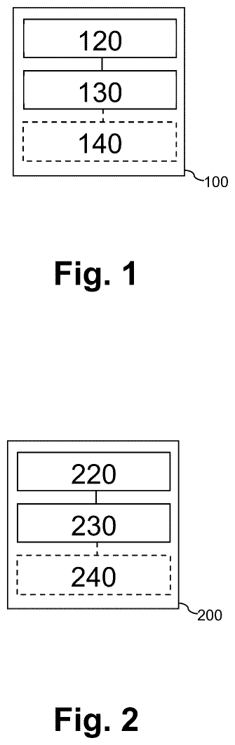

FIG. 1 illustrates a block diagram of an example of a first apparatus 100 or first device 100. The first apparatus 100 comprises circuitry that is configured to provide the functionality of the first apparatus 100. For example, the first apparatus 100 of FIG. 1 comprises interface circuitry 120, processing circuitry 130 and (optional) storage circuitry 140. For example, the processing circuitry 130 may be coupled with the interface circuitry 120 and optionally with the storage circuitry 140.

For example, the processing circuitry 130 may be configured to provide the functionality of the first apparatus 100, in conjunction with the interface circuitry 120. For example, the interface circuitry 120 is configured to exchange information, e.g., with other components inside or outside the first apparatus 100 and the storage circuitry 140. Likewise, the first device 100 may comprise means that is/are configured to provide the functionality of the first device 100.

The components of the first device 100 are defined as component means, which may correspond to, or implemented by, the respective structural components of the first apparatus 100. For example, the device first 100 of FIG. 1 comprises means for processing 130, which may correspond to or be implemented by the processing circuitry 130, means for communicating 120, which may correspond to or be implemented by the interface circuitry 120, and (optional) means for storing information 140, which may correspond to or be implemented by the storage circuitry 140. In the following, the functionality of the device 100 is illustrated with respect to the apparatus 100. Features described in connection with the first apparatus 100 may thus likewise be applied to the corresponding first device 100.

In general, the functionality of the processing circuitry 130 or means for processing 130 may be implemented by the processing circuitry 130 or means for processing 130 executing machine-readable instructions. Accordingly, any feature ascribed to the processing circuitry 130 or means for processing 130 may be defined by one or more instructions of a plurality of machine-readable instructions. The first apparatus 100 or first device 100 may comprise the machine-readable instructions, e.g., within the storage circuitry 140 or means for storing information 140.

The interface circuitry 120 or means for communicating 120 may correspond to one or more inputs and/or outputs for receiving and/or transmitting information, which may be in digital (bit) values according to a specified code, within a module, between modules or between modules of different entities. For example, the interface circuitry 120 or means for communicating 120 may comprise circuitry configured to receive and/or transmit information.

For example, the processing circuitry 130 or means for processing 130 may be implemented using one or more processing units, one or more processing devices, any means for processing, such as a processor, a computer or a programmable hardware component being operable with accordingly adapted software. In other words, the described function of the processing circuitry 130 or means for processing 130 may as well be implemented in software, which is then executed on one or more programmable hardware components. Such hardware components may comprise a general-purpose processor, a Digital Signal Processor (DSP), a micro-controller, etc.

For example, the storage circuitry 140 or means for storing information 140 may comprise at least one element of the group of a computer readable storage medium, such as a magnetic or optical storage medium, e.g., a hard disk drive, a flash memory, Floppy-Disk, Random Access Memory (RAM), Read Only Memory (ROM), Programmable Read Only Memory (PROM), Erasable Programmable Read Only Memory (EPROM), an Electronically Erasable Programmable Read Only Memory (EEPROM), or a network storage.

The processing circuitry 130 is configured to obtain data from a first party. The data is configured for training of a machine learning model of a second party. The first party the second party and a third-party (see below) may be computing systems logically and/or physically distinct from each other. Logically distinct computing systems may operate independently in terms of control, functionality, control, and/or data management etc. regardless of whether they share the same physical infrastructure.

For example, the first party may be logically distinct computing system configured to provide and control the data for training the machine learning model. A first entity may control the first party, meaning the first entity may have authority over the data of the first party. For example, the first entity may be the owner of the data or an administrator responsible for managing the data. For example, the data may be obtained by the processing circuitry 130 from the first party via the interface 120. For example, the first party may be the first apparatus 100. In this case, for example, the data may be obtained via the interface 120 from the storage circuitry 140. For In another example, the data may be obtained via the interface 120 from the first party, for example via the internet.

For example, the second party may be a logically distinct computing system, such as the second apparatus 200 (see FIG. 2 below), configured provide and control the machine learning model (and/or training the machine learning model). A second entity may control the second party, meaning the second entity has authority over the machine learning model (and/or its training process). For instance, the second entity could be the developer, owner and/or an administrator of the machine learning model.

A machine learning model may be a mathematical representation or algorithm designed to learn patterns from data and make predictions and/or decisions without being explicitly programmed for a specific task. The trained machine learning model may take in data, processes it, and generates outputs based on patterns it identifies. There are different types of machine learning models such as decision trees, support vector machines (SVMs), regression models, Bayesian models, artificial neural networks (ANNs), etc. In particular, ANN-based machine learning models comprise several well-known categories, such as feedforward neural networks (FNNs), convolutional neural networks (CNNs) for image recognition tasks, recurrent neural networks (RNNs) and long short-term memory networks (LSTMs) for sequence-based tasks like time-series forecasting or natural language processing, transformers for advanced language models and attention mechanisms (such as ChatGPT etc.), generative adversarial networks (GANs) for generating synthetic data or images, and autoencoders for unsupervised learning and data compression.

Training the machine learning model may involve feeding it training data and allowing it to adjust its internal parameters, such as weights in the case of an artificial neural network (ANN), to improve its accuracy over time. The training process may vary depending on the type of model. There are different types of learning, such as supervised learning, unsupervised learning, reinforcement learning, and semi-supervised learning. In supervised learning, the model is provided with labeled data (input-output pairs), and it learns to map inputs to the correct outputs by minimizing the difference between its predictions and the actual outputs. In unsupervised learning, the model is given unlabeled data and must find patterns or structure within the data, such as grouping similar data points together or identifying anomalies. Training the machine learning model may involve using algorithms like gradient descent to iteratively adjust the model's parameters (such as weights in the case of an ANN) to optimize performance, typically measured by metrics like accuracy, loss, or precision. Depending on the quality of the training data, the trained model's ability may be improved to varying degrees. If for example, the training data is of very poor quality (for example if it is poisoned, see below), the trained machine learning model's ability may even deteriorate significantly, for example leading to incorrect or unreliable outputs.

The obtained data for training the machine learning model may comprise one or more training samples for the machine learning model. In some examples, the obtained data may comprise one or more images, one or more videos, one or more audio samples and/or one or more text data, such as source code, documents, transcripts etc.

The processing circuitry 130 is further configured to generate metadata corresponding to the data. The metadata may comprise additional information about the data, which may be used to describe, identify, and/or manage the data. In some examples, the metadata may comprise a usage requirement for data use and/or additional information delivered after the usage requirement is fulfilled. The information delivered once those usage requirements are fulfilled may comprise a controlled mechanism for accessing sensitive or restricted data. The usage requirements for data use may comprise conditions that must be met before the data is allowed to use. In some examples, the usage requirements for data use may comprise conditions that must be met before the data is even made available for training of the machine learning model. In some examples, once the conditions are satisfied, the system may automatically provide the additional information needed to access the data, such as a decryption key or the like, or other relevant details that enable the use of the data. For instance, if a payment is required to access training data for a machine learning model, the metadata might keep the data encrypted until the payment is processed, at which point the encryption key is delivered to the user, allowing them to decrypt and use the data. In some examples, the data may be available and may be consumed at all times (not encrypted), but data may not be used for model training. To un-poison the data may be encrypted as described above and below

In some examples, the metadata comprises an identifier of the data. The identifier of the data may be a unique reference, which corresponds to data. The identifier may be a cryptographic fingerprint of the data, ensuring that any modification to the data will result in a completely different identifier, allowing for tamper detection. In some examples, generating the identifier of the data comprises generating a hash of the data. The identifier may be a hash value, which is a fixed-length string of characters generated through a cryptographic hash function (e.g., SHA-256) that takes the data and/or the metadata as input and produces the hash as a unique output. This hash function ensures that even a small change in the metadata and/or data (for instance the removing of a watermark) will result in a completely different hash value, making the identifier both unique and tamper evident. The hash of the data and/or metadata allows for efficient referencing, comparison, and verification of the data's integrity, as the identifier can be easily recalculated to ensure that the data has not been altered. In some examples, the metadata, for example the identifier itself, may comprise a direct link to the data itself that may be published at another location (such as the internet, see below).

The processing circuitry 130 is further configured to publish the data appended with the corresponding metadata. In other words, the data appended with the metadata is made available to interested systems or users for retrieval, analysis, or use in machine learning model training. For example, the data appended with the metadata is published through a network-accessible platform. This platform may be the internet, an intranet, an extranet, or a private network. The network-accessible platform may comprise a cloud service, web server, or distributed ledger, where the data appended with the metadata is stored to make it available to the relevant entities and allow for access to the data. Depending on the platform's settings, the combined data and metadata may be made available publicly or restricted to authorized users through access control mechanisms. By publishing the data appended with the metadata, it becomes usable by various systems or users, such as data scientists or developers, for training different machine learning models. For example, the data appended with the metadata may be published on a website or platform like Kaggle or UCI Machine Learning Repository for use in machine learning and model development.

For example, the metadata may be appended to the data by embedding the metadata into the header of a suitable data structure and the data into the payload of the data structure. For example, as a data structure JavaScript Object Notation (JSON) or extensible Markup Language (XML) may be used. In some examples, the metadata may be linked externally through a reference or identifier to the data. In this case, the metadata may be stored in a separate database or file, and the data contains a reference, such as a unique identifier or hash, to link back to the metadata.

The processing circuitry 130 is further configured to transmit the metadata for storage to a trusted third-party. For example, the third-party may be a logically distinct computing system, such as the third apparatus 300 (see FIG. 300), configured to securely store and/or provide the metadata corresponding to the data and/or verify the fulfillment of a usage requirement. A third entity may control the third-party, meaning the third entity has authority over the stored metadata. For example, the third entity may be a trusted escrow, intermediary, verification service or an administrator responsible for ensuring the integrity and availability of the metadata and/or verifying the fulfillment of the usage requirement. The trusted escrow, intermediary, and/or administrator may act as a neutral and secure custodian of the metadata.

The trusted third-party may securely manage the metadata and/or verify data access and usage compliance. The metadata comprises an identifier to the original data (such as a cryptographic fingerprint). By storing the metadata with a secure third-party, it ensures an immutable and tamper-proof record of the original data. In other words, this immutable record guarantees that the data itself and/or the owner's usage requirements are not altered, or that any tampering is detected. The reference to the data (hash) may provide a direct link to the specific dataset, ensuring it can be verified against the original without revealing the actual data stored at the third-party.

In some examples, the metadata may further comprise a usage requirement for data use and/or additional information that is delivered once the usage requirement is fulfilled. For example, the trusted third-party may serve as a verifier for the fulfillment of usage requirements. That is, when the second entity or the machine learning model owner or other user attempts to access the data appended with the metadata, they may fulfill the usage requirements (e.g., payment). Afterward, they can request from the third-party to attest that they have met the requirements and/or to provide the additional information (such as decryption keys or access rights) necessary to access the data (see also below for more detail).

The third party may be trusted because it provides data integrity by preventing tampering of the stored data. In some examples, the trusted third-party comprises at least one of the following: a digital ledger, a distributed digital ledger, a trusted digital escrow. The digital ledger may be an electronic record-keeping system used to store, track, and manage transactions, data entries, or other relevant information. It functions as a database where entries are chronologically ordered and typically immutable, ensuring that the data is accurate and can be verified. Digital ledgers are commonly used in financial, legal, and data management systems to provide a transparent, secure record of activities. The distributed digital ledger may be a type of digital ledger that is replicated across multiple locations or participants in a network, ensuring that all copies are synchronized and consistent. Each participant in the network holds a copy of the ledger, and updates to the ledger are collectively agreed upon through a consensus mechanism. Distributed digital ledgers, such as blockchains, provide enhanced security, transparency, and decentralization, making them resilient to tampering or single points of failure. For example, the distributed ledger may be a blockchain, such as the Bitcoin blockchain. The trusted digital escrow may be a neutral third-party service that securely holds data (digital assets, information, or cryptographic keys) on behalf of one or more parties, releasing them only when pre-agreed conditions are met. This service may act as a secure intermediary, ensuring that all parties fulfill their obligations before completing the transaction or exchange. In digital systems, a trusted digital escrow may ensure the integrity and security of sensitive information or assets, reducing the risk of fraud or disputes.

The technique described offers a secure and reliable mechanism for managing and/or verifying data used in machine learning, benefiting both the data owner and the user. By generating metadata that includes an identifier of the data and transmitting it to a trusted third-party for storage, the system ensures an immutable, tamper-proof record of both the data and any associated usage requirements. This secure storage at a trusted third-party provides a verifiable way to check the authenticity and integrity of the data, preventing unauthorized alterations. This is particularly important in multi-party environments, where data is often shared across entities, as it ensures that the data being used for training remains traceable and verifiable against the original metadata stored at the third-party.

The technique also extends this security by allowing the trusted third-party to act as a neutral verifier of data usage compliance. When a machine learning model is trained by a second party, the metadata stored at the trusted third-party can verify and/or certify that any required conditions (such as payment or licensing agreements) have been fulfilled. This independent verification not only adds a layer of trust between parties but also ensures that the data owner maintains control over how their data is used. By securely tracking these conditions, the system provides transparency, compliance, and legal protection in the event of disputes, while also streamlining the data-sharing process across different entities.

Moreover, the disclosed technique involves publishing the data appended with the corresponding metadata on a network-accessible platform, making the data readily available to many users while maintaining a direct link to the metadata stored at the trusted third-party. This publishing of the data appended with the metadata ensures that even as the data is distributed or used in various contexts, it remains traceable to its source, and the data can be verified against the third-party stored metadata. This dual mechanism of publishing of the data and secure storage of the metadata provides a comprehensive framework for managing data integrity, usage control, and compliance in machine learning workflows, ensuring that both the data owner and the data user have a reliable and secure system for data handling.

In some examples, the data is poisoned data. Poisoned data may refer to data that has been deliberately manipulated or corrupted to negatively affect the performance of a machine learning model trained with it. Poisoned data aims to distort the learning process, causing the model to learn incorrect patterns, develop biases, or perform poorly during inference. The poisoning may involve making subtle or overt changes to the data that lead the model to form flawed relationships between inputs and outputs. These manipulations can result in a model that behaves unpredictably, making wrong predictions or classifications, or even becoming vulnerable to specific attacks once deployed. In some examples, the poisoning may be detectable to a human observer, for example, if it involves blatant distortions or outliers in the dataset, such as nonsensical values or images that clearly don't belong to the intended categories. However, more advanced poisoning techniques can be undetectable, where the changes are so subtle that they are indistinguishable by humans from legitimate data, making it difficult to spot during manual inspection. These types of attacks can be particularly dangerous because they silently degrade model performance without raising immediate red flags during the training phase.

For example, the poisoning of the data may comprise maliciously mislabeling one or more samples of the data, that is giving a sample deliberately an incorrect label. As a result, the machine learning model may learn to associate the wrong input features with specific outputs, leading to classification errors in future predictions. For instance, an individual image of a cat may be intentionally mislabeled as a dog, causing the machine learning model to misclassify similar images during inference. In another example, poisoning one or more images of the data may comprise subtly altering the one or more images by modifying its pixels in a way that is imperceptible to the human eye but causes the model to misinterpret it—such as an altered stop sign image being recognized as a yield sign by the model. In another example, if the data comprises one or more text files, such as source code, poisoning may comprise introducing subtle logic errors or security vulnerabilities. For instance, a small segment of code could be altered to include a hidden bug or backdoor, leading the machine learning model trained on that poisoned data to learn incorrect or insecure programming patterns. This could result in the model generating faulty or exploitable code when applied in real-world development environments. For example, the poisoning may be done as described in the scientific paper “Nightshade: Prompt-specific poisoning attacks on text-to-image generative models.”, by Shan, Shawn, et al., published at arXiv preprint arXiv:2310.13828 (2023). In another example, the poisoning may be done as described in the scientific paper “Coprotector: Protect open-source code against unauthorized training usage with data poisoning.”, by Sun, Zhensu, et al., published in Proceedings of the ACM Web Conference 2022. 2022. The processing circuitry 130 may be configured to publish this data as described above in as poisoned data. Thereby, any unauthorized user who accesses it and attempts to use it without fulfilling the required conditions will train their machine learning model on poisoned data that leads to incorrect or harmful outputs.

In some examples, the processing circuitry 130 is further configured to obtain un-poisoning data. The un-poisoning data is configured to at least partly un-poison the poisoned data. Un-poisoning data may be used to identify and correct modifications made during the poisoning process, at least partly transforming the poisoned data back to partly or fully un-poisoned data. In other words, based on the un-poisoning data, the effects on the poisoned data are at least partly or fully reversed to restore the data to its original state. The un-poisoning data may be a specific type of corrective data designed to either fully or partially reverse the effects of poisoning. This un-poisoning data may include detailed corrections, such as restoring altered values or identifying erroneous labels, instructions on how to reverse specific manipulations introduced during the poisoning process, or additional data points that replace or supplement the poisoned elements. These corrections may comprise pixel-level changes in images, re-labeling of data entries, or fixes to specific data points that were intentionally modified to degrade the machine model's performance. The un-poisoning data may also comprise contextual information to guide the machine learning model on how to properly process the restored data, ensuring that the model learns accurate patterns and avoids the skewed or harmful effects that resulted from the poisoned data.

For example, the un-poisoning data may be generated during the poisoning process itself. This allows the data owner to precisely control the restoration of the data, as the un-poisoning data directly corresponds to the alterations made. For instance, if the data comprises one or more images and pixels in the images are altered during the poisoning, the un-poisoning data may specify which pixels need to be reverted to their original state. The un-poisoning data may include a list of offsets to the modified or poisoned pixels along with their original values before the poisoning was applied, enabling the image to be fully or partially restored to its original form.

In some cases, the un-poisoning data may be designed to only partially un-poison the data, depending on the user's access level, such as based on the payment amount the user has paid. For instance, if the data comprises one or more images, the images may be partially or fully un-poisoned, i.e., some pixels may be corrected while others remain altered, depending on how much of the un-poisoning data is made available to the user. Similarly, if the data comprises poisoned source code, critical vulnerabilities may be fixed while minor issues are left in place, providing the data owner with flexible control over the dataset's usability and ensuring that access to fully corrected data is granted only to those who meet the required conditions.

In some examples, the processing circuitry 130 is further configured to generate the poisoned data as described above. In some examples, the processing circuitry 130 is configured to transmit the data to an external poisoning entity and obtain the poisoned data back from the poisoning entity. Accordingly, in some examples, the processing circuitry 130 is further configured to generate the un-poisoning data as described above. In some examples, the processing circuitry 130 is configured to transmit the data to an external poisoning entity and obtain the un-poisoning back from the poisoning entity.

In some examples, the un-poisoning data is encrypted. Encryption ensures that the un-poisoning data remains protected from unauthorized access, allowing it to be safely transmitted or stored. The encryption process may be based on a cryptographic key, which is necessary for both encrypting and decrypting the data. For example, symmetric encryption or asymmetric encryption may be used. In symmetric encryption the same key may be used for both encrypting and decrypting the data. In In asymmetric encryption, a public-private key pair may be generated. The public key may be used for encryption of the un-poisoning data and the private key for decryption of the encrypted un-poisoning data.

In some examples, the processing circuitry 130 may perform the encryption and generate the necessary keys. For example, the processing circuitry 130 may then provide the decryption key for the encrypted un-poisoning data, that is either the symmetric key or the private key of the public-private key pair to the trusted third party. In some examples, the processing circuitry 130 is further configured to transmit the un-poisoning data to the trusted third-party. The trusted third party may encrypt the un-poisoning data. The trusted third party may then store decryption key for the encrypted un-poisoning data, that is either the symmetric key or the private key of the public-private key pair. The processing circuitry 130 may be further configured to receive encrypted un-poisoning data from trusted third-party.

In some examples, the encrypted un-poisoning data may be included in the metadata, either by the trusted third party or by the processing circuitry. The encrypted un-poisoning data may be considered additional information delivered after the usage requirement is fulfilled.

The third party may hold the decryption key for the encrypted un-poisoning data. Once a user has fulfilled certain usage requirements—such as making a required payment—the third party may transmit the decryption key to the user, allowing them to access the un-poisoning data and make the data usable again. The extent of the un-poisoning by the decrypted un-poisoning data may vary based on factors like the payment amount, meaning that in some cases, the un-poisoning data provided may only partly restore the data, depending on the user's level of access or payment (see also below).

In some examples, the decryption key may be stored by the apparatus 100 or by the first party and delivered to a user a once certain usage requirements are fulfilled.

In some examples, the processing circuitry 130 is further configured to insert a watermark into the data. A watermark may be embedded information that is inserted into the data, identifiable in the trained model, and does not degrade the performance of the trained model. The watermark may, however, be invisible or undetectable to humans, making it difficult to remove. That is the watermark embedded in the data is designed to not degrade the performance of the machine learning model trained on that data. The watermark is inserted such that it preserves the key features and patterns needed for the model to learn effectively. Despite not affecting performance of the trained machine learning model, the watermark is embedded such into the data that it can be determined whether a machine learning model has been trained with watermarked data. This is because the watermark leaves a distinct, traceable pattern in the data, which, after training, may become embedded in the machine learning model's learned parameters. This enables the first party to verify that their data has been used, even after the model has been trained, ensuring ownership and compliance.

Inserting the watermark into the data may comprise embedding identifiable information in a way that does not interfere with the data's usability. For example, if the data comprises an image, the watermark may involve subtle changes to pixel values that may not be noticeable to the human eye or a visible overlay for copyright identification. If the data comprises a text file, the watermark may involve changes to character spacing, the addition of invisible characters, or embedding additional metadata such as author information or usage restrictions. If the data comprises source code, the watermark may involve inserting comments, non-functional code variations, or unique variable names to ensure traceability. For audio or video files, a watermark may be embedded through slight modifications in the frequency, pitch, or frame data, such as changing inaudible parts of an audio file or modifying frames in a way that is not perceptible to the viewer. The watermark might be hidden from human observers, ensuring it does not affect the content's appearance or functionality, or it may be clearly visible for explicit copyright or ownership claims.

The machine learning model may be fed with specific input parameters and tested to analyze its outputs in a way that reveals whether watermarked data was part of its training. For instance, running specific queries or tests against the model may expose the presence of the watermark, confirming the use of the watermarked data without degrading the model's performance. One method for detecting whether a model was trained on watermarked data is trigger-based detection. In this method, the watermark acts as a trigger that elicits a specific response from the trained model. For example, presenting an image with the same watermark pattern used during training can prompt the model to return a distinct or predefined output, confirming that it was exposed to watermarked data. In another method, known as model response to embedded features, the machine learning model may be queried with specific prompts to reveal biases or patterns that correspond to the watermarked elements, such as hidden changes in text or slight modifications to images. For instance, shifts in the feature distribution caused by the watermark may be detected by examining the model's outputs or parameters for subtle traces left by the watermarking process. This method works by detecting small, consistent deviations in how the model processes certain features, such as color distributions in images. In some examples, specific phrases or sequences may be inserted as watermarks in text data. After training, these watermarked phrases may be used as inputs to check if the machine learning model responds in a specific, predetermined way, revealing whether it was trained on the watermarked data. These techniques ensure that the presence of watermarked data can be verified without degrading the performance or accuracy of the trained model. In some examples, the watermark may encrypt the metadata corresponding to data.

In some examples, the metadata of the data further comprises at least one of the following: a payment amount for using the data for training of the machine learning model, a payment address for the payment amount, a usage constraint for the data and encrypted un-poisoning data. For example, the payment amount for using the data may specify the cost required to legally access and use the data for training a machine learning model. This component of the metadata allows the data owner to monetize their data by setting a predefined fee that must be paid before the data is allowed to be used. In some examples, however, there may be no strict enforcement of the payment; that is, the data can be used even if the payment hasn't been done. However, the user of the data may receive a certificate proving that they have paid, which could be used later on in the event of a legal dispute or the like. In another example, the data user may not be able to access the data without paying. For instance, the trusted third party may provide an encryption key to the data user only after verifying that the user has paid the required amount, ensuring that the data remains inaccessible until all conditions are fulfilled. The payment address for the payment amount may be the specific destination, such as a cryptocurrency wallet or traditional payment account, where the user must send the payment. By including a payment address, the metadata ensures that transactions are directed to the correct location, automating the payment process and allowing for easy verification of whether the payment has been received. The trusted third party may communicate with the payment system, such as querying the cryptocurrency blockchain or the legacy banking system, to verify if the payment has been successfully completed before granting access to the data.

A usage constraint for the data defines specific limitations or conditions under which the data can be used for training of a machine learning model. These constraints may include restrictions on geographic locations, types of machine learning models, timeframes during which the data can be utilized, or limitations on the purpose, such as prohibiting the data's use for military or surveillance applications. Additionally, constraints may also govern the specific environments where the data can be used, such as requiring training to occur in an attestable or secure computing environment. These usage constraints allow data owners to enforce strict policies, ensuring their data is used in accordance with licensing terms, legal compliance, and data control standards. If these conditions are not met, access to the data may be revoked or limited, protecting the data owner's rights

The encrypted un-poisoning data may be part of the metadata as described above. The trusted third-party may also store the decryption key for the encrypted un-poisoning data, which is not part of metadata.

In some examples, the processing circuitry 130 is configured to sign the metadata using a cryptographic private key. The which cryptographic private key may be part of a private-public key pair. The signing process may involve the processing circuitry 130 generating a digital signature for the metadata using the private key. This signature ensures that the metadata is both authentic and unaltered. Specifically, the digital signature may be unique to the metadata and the private key, meaning that even the slightest change in the metadata will result in a different signature, making any tampering detectable. By using the private key for signing, the processing circuitry 130 enables anyone with access to the corresponding public key to verify the authenticity of the metadata and ensure it originates from the trusted source, without having access to the private key itself.

In some examples, the processing circuitry 130 may be further configured to transmit the public key from the private-public key pair to the third trusted party. The public key is used by the third party to verify the digital signature on the metadata, confirming that the metadata was signed by the holder of the corresponding private key. By sending the public key to the third trusted party, the processing circuitry enables the third party to perform verification tasks without needing the private key, ensuring the integrity and authenticity of the metadata while keeping the private key secure. This approach ensures that the third party, or other recipients, can validate the source and integrity of the metadata while maintaining a clear separation between the verification and signing processes, enhancing overall security.

Further details and aspects are mentioned in connection with the examples described below. The example shown in FIG. 1 may include one or more optional additional features corresponding to one or more aspects mentioned in connection with the proposed concept or one or more examples described below (e.g., FIGS. 2-11).

FIG. 2 illustrates a block diagram of an example of a second apparatus 200 or second device 200. The second apparatus 200 comprises circuitry that is configured to provide the functionality of the second apparatus 200. For example, the second apparatus 200 of FIG. 2 comprises interface circuitry 220, processing circuitry 230 and (optional) storage circuitry 240. For example, the processing circuitry 230 may be coupled with the interface circuitry 220 and optionally with the storage circuitry 240.

For example, the processing circuitry 230 may be configured to provide the functionality of the first apparatus 200, in conjunction with the interface circuitry 220. For example, the interface circuitry 220 is configured to exchange information, e.g., with other components inside or outside the first apparatus 200 and the storage circuitry 240. Likewise, the first device 200 may comprise means that is/are configured to provide the functionality of the first device 200.

The components of the second device 200 are defined as component means, which may correspond to, or implemented by, the respective structural components of the first apparatus 200. For example, the second device first 200 of FIG. 2 comprises means for processing 230, which may correspond to or be implemented by the processing circuitry 230, means for communicating 220, which may correspond to or be implemented by the interface circuitry 220, and (optional) means for storing information 240, which may correspond to or be implemented by the storage circuitry 240. In the following, the functionality of the second device 200 is illustrated with respect to the second apparatus 200. Features described in connection with the second apparatus 200 may thus likewise be applied to the corresponding second device 200.

In general, the functionality of the processing circuitry 230 or means for processing 230 may be implemented by the processing circuitry 230 or means for processing 230 executing machine-readable instructions. Accordingly, any feature ascribed to the processing circuitry 230 or means for processing 230 may be defined by one or more instructions of a plurality of machine-readable instructions. The second apparatus 200 or second device 200 may comprise the machine-readable instructions, e.g., within the storage circuitry 240 or means for storing information 240.

The interface circuitry 220 or means for communicating 220 may correspond to one or more inputs and/or outputs for receiving and/or transmitting information, which may be in digital (bit) values according to a specified code, within a module, between modules or between modules of different entities. For example, the interface circuitry 220 or means for communicating 220 may comprise circuitry configured to receive and/or transmit information.

For example, the processing circuitry 230 or means for processing 230 may be implemented using one or more processing units, one or more processing devices, any means for processing, such as a processor, a computer or a programmable hardware component being operable with accordingly adapted software. In other words, the described function of the processing circuitry 230 or means for processing 230 may as well be implemented in software, which is then executed on one or more programmable hardware components. Such hardware components may comprise a general-purpose processor, a Digital Signal Processor (DSP), a micro-controller, etc.

For example, the storage circuitry 240 or means for storing information 240 may comprise at least one element of the group of a computer readable storage medium, such as a magnetic or optical storage medium, e.g., a hard disk drive, a flash memory, Floppy-Disk, Random Access Memory (RAM), Read Only Memory (ROM), Programmable Read Only Memory (PROM), Erasable Programmable Read Only Memory (EPROM), an Electronically Erasable Programmable Read Only Memory (EEPROM), or a network storage.

The processing circuitry 230 is configured to obtain data from the first party with appended metadata. The data is configured for training of the machine learning model of the second party. The first party, the second party and the third party may be as described above. For example, the second party may be a logically distinct computing system, such as the second apparatus 200 (see FIG. 2 below), configured control (and provide) the machine learning model (and/or training the machine learning model). The second entity may control the second party, meaning the second entity has authority over the machine learning model (and/or its training process). For instance, the second entity could be the developer, owner and/or an administrator of the machine learning model.

The metadata comprises information about a usage requirement of the data. The usage requirements for data use may comprise conditions that must be met before the data is allowed to use. In some examples, the usage requirement of the data comprises paying a required payment amount for using the data for training of the machine learning model to a payment address. In some examples, the usage requirements for data use may comprise conditions that must be met before the data is even made available for training of the machine learning model. In some examples, the metadata may comprise the usage requirement for data use and/or additional information delivered that is made available after the usage requirement is fulfilled as described above with regards to FIG. 1

The processing circuitry 230 is further configured to examine the metadata for the usage requirement of the data. Examining the metadata may comprise reading, analyzing, and/or evaluating the metadata attached to the data to check for any usage requirements that must be fulfilled before the data can be used. This may comprise identifying specific conditions such as payments, usage restrictions, or contractual obligations. In some examples, if the metadata is cryptographically signed, examining the metadata may further comprise verifying the digital signature, for example with a cryptographic key. The verification ensures that the metadata has not been altered and confirms the authenticity of the source that signed it, guaranteeing that the usage requirements in the metadata are valid and have been securely provided by the authorized entity. For example, the processing circuitry 130 may use a public key provided by a trusted third party to verify the digital signature on the metadata. This step ensures that the metadata has not been tampered with and originates from the correct source.

The processing circuitry 230 is further configured to perform an action to fulfill the usage requirement. Fulfilling the one or more usage requirements may comprise to actively taking steps to ensure that the one or more usage requirements specified in the metadata are met. After examining the metadata and identifying any requirements the processing circuitry 230 may initiate the necessary actions. In some examples, the processing circuitry 230 carry out the usage requirements. In some examples, the processing circuitry 230 may communicate, for example via the interface circuitry 220, with an external device and instruct the external device to carry out the usage requirements. For example, if the metadata requires a payment to a specific address, the processing circuitry 230 may initiate the payment process by communicating, for example via the interface circuitry 220, with a payment system. In some example, if the metadata stipulates that the data can only be used in a secure environment (such as a trusted execution environment (TEE), see below), the processing circuitry 220 might ensure the data is deployed within the secure environment before allowing access and may be attesting the security of the secure environment.

In some examples, once the usage requirements are satisfied, the data be allowed to be used for training of the machine learning model. In some examples, the trusted third-party may further provide additional information needed to access the data, such as a decryption key, or other relevant details that enable the use of the data. For instance, if the payment is required to access training data for a machine learning model, the metadata might keep the data encrypted until the payment is processed, at which point the encryption key is delivered to the user, allowing them to decrypt and use the data. In some examples, the processing circuitry 230 is further configured to train the machine learning model based on the data. In another example, the processing circuitry 230 may provide the data and the machine learning model to a device that may be especially suited for training the machine learning model (such as a device comprising one or more Graphics Processing Units (GPUs) or Neural Processing Units (NPUs)).

The processing circuitry 230 is further configured to receive a certificate from the trusted third-party. As described above with regards to FIG. 1, the third-party may be a logically distinct computing system, such as the third apparatus 300 (see FIG. 300), configured to securely store and/or provide the metadata corresponding to the data and/or verify the fulfillment of a usage requirement. The third entity may control the third-party. For example, the third entity may be a trusted escrow, intermediary, verification service or an administrator responsible for ensuring the integrity and availability of the metadata and/or verifying the fulfillment of the usage requirement. The certificate comprises information about the fulfilled usage requirement. The certificate may be a digital document that serves as proof that the usage requirement is fulfilled. It may be issued by the trusted third-party authority and may contain details such as the identity of the parties involved, the actions completed, and any other relevant information needed for verification. For example, the certificate may be digitally signed by the trusted third-party and may comprise information such as the completion of a payment, acknowledgment of terms, or confirmation of a license agreement. The certificate may be implemented using cryptographic methods such as public-private key pairs, where the trusted third-party signs the certificate with a private key, allowing others to verify its authenticity with a public key. This ensures that the certificate cannot be tampered with and can be trusted by all parties involved. For example, if the usage requirement is a payment for using data to train the machine learning model, the certificate may confirm that the payment has been successfully processed. In some examples, the certificate may verify that specific licensing terms have been accepted by the user before accessing the data.

In some examples, the processing circuitry 230 may be further configured to prove the fulfillment of the usage requirement based on the certificate. The certificate may be used if the first entity (for example the data owner), who originally set the usage requirements, suspects that their data was used. For instance, if the first entity detects via a watermark in the trained model that their data was used in training the machine learning model, the first entity may challenge the second entity and for example threaten legal action for unauthorized use. In response, the second entity may provide the certificate as evidence that they complied with the usage requirements, such as making a payment or agreeing to terms. The certificate, being validated by a trusted third-party, may serve as legally credible proof that the conditions were met, protecting the second entity from potential legal disputes.

The above described technique provides an improved approach for managing and verifying the usage of data in training machine learning models. By incorporating metadata with detailed usage requirements directly into the data, the system enables automatic real-time validation of conditions like payment or licensing terms, ensuring that these requirements are met before the data is used. This may reduce the risk of unauthorized access or misuse of the data, while also automating actions, such as payments, which minimizes human intervention and potential errors. Further, the generation and receiving of a certificate from a trusted third-party provides irrefutable proof of compliance, offering legal protection and establishing an immutable audit trail. The above described technique may ensure legal compliance and also enhance transparency and accountability between data owners and machine learning developers. By improving the verification process and providing traceable evidence of proper data use, it reduces friction in data-sharing agreements and fosters a mutual trust between entities. Moreover, it simplifies the complexities around data licensing and usage, making it easier for both parties to engage in collaborations, knowing that the data usage is secure, verifiable, and dispute-free. This ensures smoother, faster workflows for machine learning model development while protecting the rights and interests of data owners.

In some examples, the processing circuitry 230 may be further configured to generate a log during training of the machine learning model. The log may comprise entries about training data used in the training process and the log may further comprise an entry about the data. In some examples, the processing circuitry 230 may be further configured to prove the fulfillment of the usage requirement based on generated log. In other words, the generated log may ensure that each dataset's usage is traced and verified, creating a comprehensive, auditable record used by the second entity. The log may include entries for each dataset, comprising an entry capturing information about the data. For example, an entry may comprise a reference (such as a hash) of the data, specific usage requirements, and/or performed actions to fulfill the usage requirements etc. For example, the log may be utilized in the case of the data requiring a payment before use. The log may include in the corresponding entry of the data information that shows that the payment was made, proving that the dataset was used in accordance with the owner's terms. This allows for transparent tracking of data usage for the training of the machine learning model, ensuring compliance with the data owner's terms and providing verifiable proof of proper use. For example, the log may be a Bill of Materials (BOM). A BOM may be detailed record of all the data used in the training process.

In some examples, the processing circuitry 230 may be further configured to generate a hash structure based on the log. The hash structure may comprise linked cryptographic hashes. Each of the linked cryptographic hashes, may correspond to an individual entry in the log. The hash structure may ensure the integrity and immutability of the log by creating a chain of cryptographic proofs. Each entry in the log corresponding to data used to train the machine learning model may be hashed using a cryptographic algorithm. These linked hashes form a chain where each hash depends on the previous entry, meaning that if even one entry is altered, the chain becomes invalid. This ensures that the log is tamper-proof-any unauthorized changes to the log can be immediately detected. The cryptographic linking provides verifiable proof that the log remains unchanged, ensuring both security and traceability throughout the training process. For example, the hash structure may be a hash tree (also referred to as a Merkle tree). In a hash tree, each leaf node of the tree represents a cryptographic hash of an individual log entry. These leaf nodes are then paired and hashed together to form the next layer of the tree. This process continues, linking all the log entries together, until a single root hash is created at the top of the tree. The root hash serves as a cryptographic fingerprint for the entire log. In this structure, every log entry (such as the data used for training the machine learning model) may be linked to its cryptographic hash. If any individual entry in the log is altered or tampered with, the hash of that entry changes, and this change propagates up through the tree, altering the root hash. This structure ensures that any tampering with the log is immediately detectable and provides a strong mechanism for securing the integrity of the training process.

In some example, the metadata may further comprise at least one of the following as described above with regards to FIG. 1: the payment amount for using the data for training of the machine learning model, the payment address for the payment amount, a usage constraint for the data and encrypted un-poisoning data.

In some examples, the data is poisoned data, and the metadata further comprises the encrypted un-poisoning data. As described above, the un-poisoning data may be used to identify and correct modifications made during the poisoning process, at least partly transforming the poisoned data back to partly or fully un-poisoned data. In other words, based on the un-poisoning data, the effects on the poisoned data are at least partly or fully reversed to restore the data to its original state. The un-poisoning data may be a specific type of corrective data designed to either fully or partially reverse the effects of poisoning.

For example, the processing circuitry 230 may be further configured to decrypt the encrypted un-poisoning data. The processing circuitry 230 may be further configured to at least partly un-poison the data based on the decrypted un-poisoning data. The encryption ensures that the un-poisoning data remains protected from unauthorized access, allowing it to be safely transmitted or stored. The encryption process may be based on a cryptographic key, which is necessary for both encrypting and decrypting the data. For example, symmetric encryption or asymmetric encryption may be used. For example, the processing circuitry 230 may receive a decryption key to decrypt the encrypted un-poisoning data, for example a symmetric key or the private key of a public-private key pair.

For example, once the second party has fulfilled the usage requirements (such as making a required payment) the processing circuitry 230 may receive the decryption key. For example, the processing circuitry 230 may receive the decryption key from the second party or from the trusted third-party. For example, the trusted third-party has encrypted the un-poising data and therefore holds the decryption keys (see above). The decrypted un-poisoning data may allow the processing circuitry 230 to access the poisoned data usable again. The extent of the un-poisoning by the decrypted un-poisoning data may vary based on factors like the payment amount, meaning that in some cases, the un-poisoning data provided may only partly restore the data, depending on the user's level of access or payment. In some examples, the second party may not want to pay the full payment amount for using the data for training of the machine learning model because the second party may not need the machine learning model to be trained on that good data. In other words, in some cases, the un-poisoning data may be designed to only partially un-poison the data, depending on the second party's access level, such as based on the payment amount the user has paid. For instance, if the data comprises one or more images, the images may be partially or fully un-poisoned, i.e., some pixels may be corrected while others remain altered, depending on how much of the un-poisoning data is made available to the user. Similarly, if the data comprises poisoned source code, critical vulnerabilities may be fixed while minor issues are left in place, providing the data owner with flexible control over the dataset's usability and ensuring that access to fully corrected data is granted only to those who meet the required conditions.

In some examples, the processing circuitry 230 is further configured to instantiate a trusted execution environment (TEE). For example, the processing circuitry 230 is further configured to attest the integrity of the trusted execution environment to the trusted third-party. For example, one or more or all steps performed by the processing circuitry 230 may be performed within the instantiated TEE. For example, the processing circuitry 230 may instantiate the TEE and then securely execute the above described steps within the TEE. For example, the processing circuitry 230 may perform one or more of the following steps in the TEE: obtain the data and the metadata from a first party; examine the metadata; perform the action to fulfill the usage requirement; receive the certificate from a trusted third-party; generate the log; decrypt the encrypted un-poisoning data; at least partly un-poison the poisoned data etc.

A TEE (also referred to as TEE architecture to distinguish from an instance of the TEE) may comprise a combination of specialized hardware and software components designed to protect data and computations from unauthorized access and tampering within a computer system. The TEE architecture may provide secure processing circuitry, which is responsible for executing sensitive workloads in an isolated environment. Additionally, the TEE architecture may provide secure memory, such as a protected region of the computer system's RAM, where sensitive data can be stored during computation. To further safeguard this data, the TEE architecture may provide memory encryption, ensuring that the contents of the system memory are protected even if physical access to the memory is obtained. For example, the TEE architecture may support I/O isolation and secure input/output operations, preventing data leakage during communication between the processing circuitry and peripheral devices. In some examples, the TEE architecture may provide secure storage capabilities of the computer system, such as a secure partition within the system's main storage, dedicated to storing cryptographic keys, sensitive configuration data. This secure storage ensures that critical data remains protected even when at rest. In some examples, the TEE architecture may also comprise separate secure storage components, such as a tamper-resistant storage chip, like an integrity measurement register, to securely store measurements of the TEE and/or critical data associated with the TEE's operation. A host, such as the second apparatus 200, may generate an instance of TEE, that is instantiate the TEE, based on the TEE architecture. The instance of the TEE architecture may be referred to as a TEE. The TEE uses its components to enable the secure and isolated execution of workloads. A workload executed in the TEE may include the steps of the technique as described above, a set of applications, tasks, or processes that are actively managed and protected by these secure hardware components. This includes computational activities that utilize the TEE's resources, including CPU, memory, and storage, to perform their operations. The TEE ensures that these workloads are protected from unauthorized access and tampering by leveraging hardware-based security features and cryptographic measures, thereby maintaining the integrity and confidentiality of the data and processes throughout their execution.

In some examples, the trusted execution environment may be an Intel® TDX trusted domain or an Intel® SGX enclave. The trusted domain may be considered as an instance of the TDX. The enclave may be considered as an instance of the SGX.

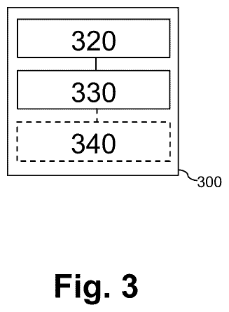

Further details and aspects are mentioned in connection with the examples described above or below. The example shown in FIG. 2 may include one or more optional additional features corresponding to one or more aspects mentioned in connection with the proposed concept or one or more examples described above (e.g., FIGS. 1-2) or below (e.g., FIGS. 3-11).

FIG. 3 illustrates a block diagram of an example of a third apparatus 300 or third device 300. The third apparatus 300 comprises circuitry that is configured to provide the functionality of the third apparatus 300. For example, the third apparatus 300 of FIG. 3 comprises interface circuitry 320, processing circuitry 330 and (optional) storage circuitry 340. For example, the processing circuitry 330 may be coupled with the interface circuitry 320 and optionally with the storage circuitry 340.

For example, the processing circuitry 330 may be configured to provide the functionality of the third apparatus 300, in conjunction with the interface circuitry 320. For example, the interface circuitry 320 is configured to exchange information, e.g., with other components inside or outside the third apparatus 300 and the storage circuitry 340. Likewise, the third device 300 may comprise means that is/are configured to provide the functionality of the third device 300.

The components of the third device 300 are defined as component means, which may correspond to, or implemented by, the respective structural components of the third apparatus 300. For example, the device third 300 of FIG. 3 comprises means for processing 330, which may correspond to or be implemented by the processing circuitry 330, means for communicating 320, which may correspond to or be implemented by the interface circuitry 320, and (optional) means for storing information 340, which may correspond to or be implemented by the storage circuitry 340. In the following, the functionality of the device 300 is illustrated with respect to the apparatus 300. Features described in connection with the third apparatus 300 may thus likewise be applied to the corresponding third device 300.

In general, the functionality of the processing circuitry 330 or means for processing 330 may be implemented by the processing circuitry 330 or means for processing 330 executing machine-readable instructions. Accordingly, any feature ascribed to the processing circuitry 330 or means for processing 330 may be defined by one or more instructions of a plurality of machine-readable instructions. The third apparatus 300 or third device 300 may comprise the machine-readable instructions, e.g., within the storage circuitry 340 or means for storing information 340.

The interface circuitry 320 or means for communicating 320 may correspond to one or more inputs and/or outputs for receiving and/or transmitting information, which may be in digital (bit) values according to a specified code, within a module, between modules or between modules of different entities. For example, the interface circuitry 320 or means for communicating 320 may comprise circuitry configured to receive and/or transmit information.

For example, the processing circuitry 330 or means for processing 330 may be implemented using one or more processing units, one or more processing devices, any means for processing, such as a processor, a computer or a programmable hardware component being operable with accordingly adapted software. In other words, the described function of the processing circuitry 330 or means for processing 330 may as well be implemented in software, which is then executed on one or more programmable hardware components. Such hardware components may comprise a general-purpose processor, a Digital Signal Processor (DSP), a micro-controller, etc.

For example, the storage circuitry 340 or means for storing information 340 may comprise at least one element of the group of a computer readable storage medium, such as a magnetic or optical storage medium, e.g., a hard disk drive, a flash memory, Floppy-Disk, Random Access Memory (RAM), Read Only Memory (ROM), Programmable Read Only Memory (PROM), Erasable Programmable Read Only Memory (EPROM), an Electronically Erasable Programmable Read Only Memory (EEPROM), or a network storage.

The processing circuitry 330 is configured to store the metadata corresponding to data of the first party. The data is configured for training of the machine learning model of the second party. The metadata comprises an identifier of the data. In some examples, the processing circuitry 330 may be configured to store the metadata at a digital ledger, a distributed digital ledger, and/or trusted digital escrow. These are secure, tamper-resistant platforms that ensure the metadata, such as data usage requirements, is recorded in a way that can be verified and trusted by multiple parties.

The processing circuitry 330 is further configured to receive a request for a certificate from a requestor. The certificate comprises evidence that a usage requirement of the data is fulfilled. The processing circuitry 330 is further configured to evaluate if the usage requirement of the data is fulfilled (for example fulfilled by the requestor). The processing circuitry 330 is further configured to transmit the certificate to the requestor, if the usage requirement of the data is fulfilled. In some examples, the requestor of the certificate is the second entity via the second party.

For example, the apparatus 300 may the third-party. The third-party may be a logically distinct computing system, configured to securely store and/or provide the metadata corresponding to the data and/or verify the fulfillment of a usage requirement. The third entity may control the third-party, meaning the third entity has authority over the stored metadata. For example, the third entity may be a trusted escrow, intermediary, verification service or an administrator responsible for ensuring the integrity and availability of the metadata and/or verifying the fulfillment of the usage requirement. The trusted escrow, intermediary, and/or administrator may act as a neutral and secure custodian of the metadata. As described above the, the trusted third party may be trusted because it provides data integrity by preventing tampering of the stored data. In some examples, the trusted third-party comprises at least one of the following: a digital ledger, a distributed digital ledger, a trusted digital escrow. The trusted third-party may securely manage the metadata and/or verify data access and usage compliance. The metadata comprises an identifier to the original data (such as a cryptographic fingerprint). By storing the metadata with a secure third-party, it ensures an immutable and tamper-proof record of the original data. In other words, this immutable record guarantees that the data itself and/or the owner's usage requirements are not altered, or that any tampering is detected. The reference to the data (hash) may provide a direct link to the specific dataset, ensuring it can be verified against the original without revealing the actual data stored at the third-party.

In some examples, the metadata may further comprise a usage requirement for data use and/or additional information that is delivered once the usage requirement is fulfilled. For example, the trusted third-party may serve as a verifier for the fulfillment of usage requirements. That is, when the second entity such as the machine learning model owner or any other user attempts to access the data appended with the metadata, they may fulfill the usage requirements (e.g., payment). Afterward, they can request from the third-party to attest that they have met the requirements and/or to provide the additional information (such as decryption keys or access rights) necessary to access the data (see also below for more detail).

Evaluating if the usage requirement of the data is fulfilled may comprise reviewing and verifying whether the specified usage requirements for a dataset have been fulfilled before allowing the data to be used. This may comprise checking the conditions embedded in the metadata, such as payment obligations, licensing terms, or other contractual stipulations. In some examples, evaluating if the usage requirement is fulfilled comprises making a request to an external system. In some examples, the processing circuitry 330 is further configured to receive evidence from the external system that the usage requirement is fulfilled. For example, the external system may be a payment processing platform, such as bank or a cryptocurrency wallet.

For example, if the usage requirement includes a payment condition, the processing circuitry 330 may interact with the payment processing platform to verify that the payment has been successfully completed. This may comprise querying the platform to confirm that the correct amount was transferred to the appropriate account. Once the payment is validated, the third party issues a certificate proving that the user has met this condition, enabling access to the data for training purposes. In some example, the evaluating may comprise verifying licensing terms. If the metadata includes a requirement that the user must agree to certain terms before using the data, the third party may check a licensing server to confirm that the user has accepted the necessary agreements. The processing circuitry 330 may track whether the user has agreed to specific terms and conditions before data access is granted. After confirming the license agreement, the third party would issue an authorization signal, confirming compliance and allowing the data to be used for its intended purpose.

In some examples, the processing circuitry 330 may generate the certificate if the usage requirement of the data is fulfilled. In some examples, the processing circuitry 330 may obtain the certificate from an external device (for example via the interface circuitry 320), for example for the external system, if the usage requirement of the data is fulfilled. The certificate may be a digital document that serves as proof that the usage requirements of the data have been fulfilled. The certificate may comprise information such as the details of the fulfilled requirement (e.g., payment made, licensing accepted), the identity of the parties involved, a timestamp, and/or a reference to the dataset. For example, the certificate may be in formats like XML, JSON, or other structured data formats that allow easy machine-readable processing. To ensure authenticity and security, the certificate may be digitally signed using a private key from a public-private key pair. This ensures that the certificate cannot be altered without detection and can be verified by anyone holding the corresponding public key. Additionally, the certificate may include cryptographic hashes of the associated metadata or log entries, ensuring that the data's integrity is maintained and traceable.

The above described technique described enables the trusted third-party (for example the verifier) to strengthen the system's (first, second and third party) overall security, as the third party ensures that no data is used until all conditions are satisfied, thereby preventing unauthorized access. The ability to store metadata and issue a certificate further enhances the credibility of the process, as the verifier's certificate provides legally recognized proof of compliance. Further, the third party's ability to evaluate usage requirements and issue certificates benefits all parties by ensuring transparency and trust. By acting as a neutral third party, the third party eliminates the need for direct oversight between the data owner and the machine learning model developer, reducing potential conflicts or disputes. The third parties certificate provides irrefutable proof that the usage requirements have been fulfilled, giving confidence to both the data owner and the developer. This reduces the administrative burden on both parties, as they can rely on the verifier's independent assessment to confirm compliance. Further, the third party ensures that the system is efficient, reducing delays in data sharing and speeding up machine learning workflows. For the third party, this system establishes them as a key authority in data compliance, strengthening their role as a trusted intermediary. The compliance checks, along with the ability to issue cryptographically signed certificates, positions the verifier as the guarantor of legal and operational security in the data exchange process. By handling these verification tasks, the third party ensures that data usage remains secure, transparent, and compliant with all agreed-upon requirements. This trusted role further solidifies the verifier's position in the broader data-sharing infrastructure, enhancing their relevance in multi-party collaborations.

In some examples, the processing circuitry 330 may be further configured to receive un-poisoning data. As described above the un-poisoning data is configured to at least partly un-poison the poisoned data. Further, the processing circuitry 330 may be further configured to encrypt the un-poisoning data. As described above, the processing circuitry 330 may encrypt with a symmetric key or the public key of the public-private key pair. That is the processing circuitry 330 may also have the corresponding decryption key for the encrypted un-poisoning data, that is either the symmetric key or the private key of the public-private key pair. For example, the decryption key may be stored in the storage circuitry 340.

In some examples, the processing circuitry 330 may be further configured to transmit the encrypted un-poisoning data to the transmitter of the un-poisoning data. For example, the transmitter of the un-poisoning data is the first entity, for example, the data owner. In some examples, the encrypted un-poisoning data may be included in the metadata. The encrypted un-poisoning data may be considered additional information delivered after the usage requirement is fulfilled.

The processing circuitry 330 may hold the decryption key for the encrypted un-poisoning data, for example, the decryption key may be stored in the storage circuitry 340. For example, the processing circuitry 330 may transmit the decryption key to the requestor if the if the usage requirement of the data is fulfilled by the requestor. In some examples, the certificate may further comprise the decryption key to the encrypted un-poisoning data and/or the decrypted un-poisoning data. As described above the extent of the un-poisoning by the decrypted un-poisoning data may vary based on factors like the payment amount, meaning that in some cases, the un-poisoning data provided may only partly restore the data, depending on the user's level of access or payment. For example, the processing circuitry 330 may generate different decryption keys, wherein they are configured to decrypt the encrypted un-poisoning data to different specific amounts. In another example, the poisoning may be performed in multiple iterations. Depending on the number of poisoning iterations, the resulting data may be of different poisoned quality. For example, more poisoning iterations may create poisoned data of lower quality. The corresponding un-poisoned data may then contain the reverse information to un-poison each iteration. The amount of access to the number of un-poison iteration information may be dependent on the payment.

Further details and aspects are mentioned in connection with the examples described above or below. The example shown in FIG. 3 may include one or more optional additional features corresponding to one or more aspects mentioned in connection with the proposed concept or one or more examples described above (e.g., FIGS. 1-2) or below (e.g., FIGS. 3-11).

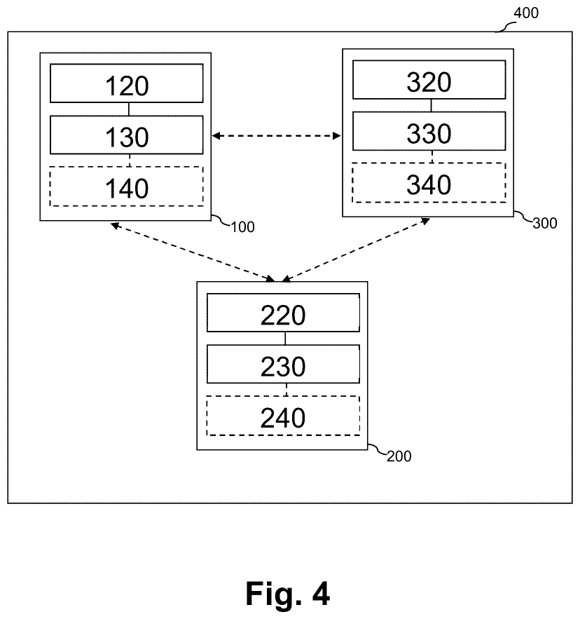

FIG. 4 illustrates a block diagram of an example of a system 400 comprising the first apparatus 100, the second apparatus 200 and the third apparatus 300.

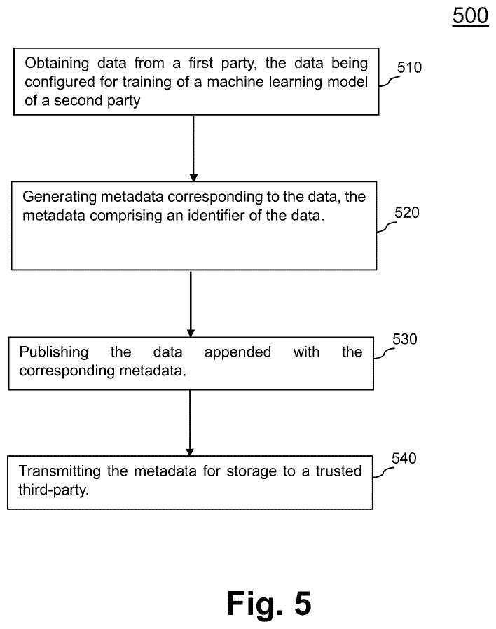

Further details and aspects are mentioned in connection with the examples described above or below. The example shown in FIG. 4 may include one or more optional additional features corresponding to one or more aspects mentioned in connection with the proposed concept or one or more examples described above (e.g., FIGS. 1-3) or below (e.g., FIGS. 5-11).

FIG. 5 illustrates a flowchart of an example of a first method 500. The method 500 may, for instance, be performed by an apparatus as described herein, such as apparatus 100. The method 500 comprises obtaining 510 data from a first party, the data being configured for training of a machine learning model of a second party. The method 500 further comprises generating 520 metadata corresponding to the data, the metadata comprising an identifier of the data. The method 500 comprises further publishing 530 the data appended with the corresponding metadata. The method 500 further comprises transmitting 540 the metadata for storage to a trusted third-party.

More details and aspects of the method 500 are explained in connection with the proposed technique or one or more examples described above, e.g., with reference to FIG. 1. The method 500 may comprise one or more additional optional features corresponding to one or more aspects of the proposed technique, or one or more examples described above or below.

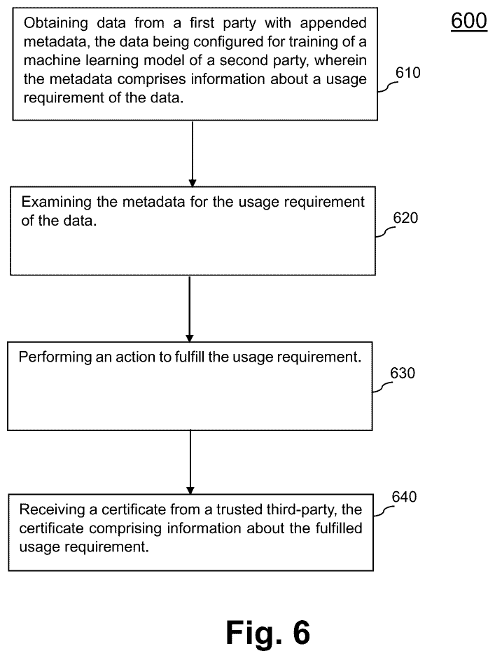

FIG. 6 illustrates a flowchart of an example of a second method 600. The method 600 may, for instance, be performed by an apparatus as described herein, such as apparatus 100. The method 600 comprises obtaining 610 data from a first party with appended metadata. The data is configured for training of a machine learning model of a second party. The metadata comprises information about a usage requirement of the data. The method 600 further comprises examining 620 the metadata for the usage requirement of the data. The method 600 further comprises performing 630 an action to fulfill the usage requirement. The method 600 further comprises receiving 640 a certificate from a trusted third-party, the certificate comprising information about the fulfilled usage requirement.

More details and aspects of the method 600 are explained in connection with the proposed technique or one or more examples described above, e.g., with reference to FIG. 2. The method 600 may comprise one or more additional optional features corresponding to one or more aspects of the proposed technique, or one or more examples described above or below.

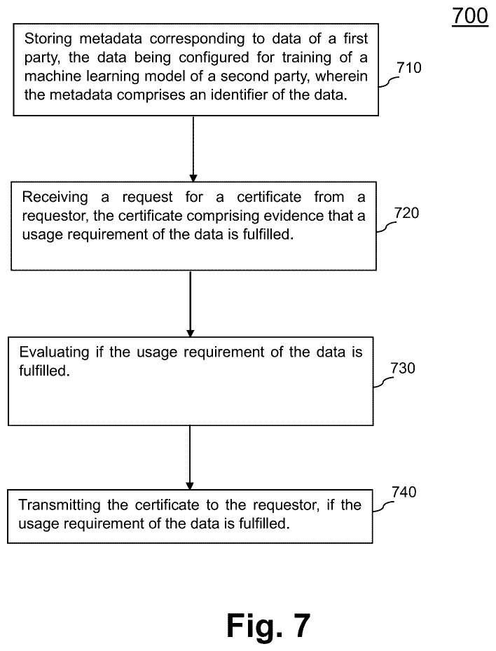

FIG. 7 illustrates a flowchart of an example of a third method 700. The method 700 may, for instance, be performed by an apparatus as described herein, such as apparatus 100. The method 700 comprises storing 710 metadata corresponding to data of a first party. The data is configured for training of a machine learning model of a second party. The metadata comprises an identifier of the data. Further, the method 700 comprises receiving 720 a request for a certificate from a requestor. The certificate comprise evidence that a usage requirement of the data is fulfilled. Further, the method 700 comprises evaluating 730 if the usage requirement of the data is fulfilled. Further, the method 700 comprises transmitting 740 the certificate to the requestor, if the usage requirement of the data is fulfilled

More details and aspects of the method 700 are explained in connection with the proposed technique or one or more examples described above, e.g., with reference to FIG. 3. The method 700 may comprise one or more additional optional features corresponding to one or more aspects of the proposed technique, or one or more examples described above or below.

### Further Examples

In a first example, building blocks like watermarking and/or distributed ledger may be combined into a mechanism introducing policies or requirements which the second entity (such as a machine learning model company also referred to as AI company) may fulfill to legally use a data set owned by somebody else. In the first example, it may be assumed that the first entity (for example the data owner) publishes the data set along with a watermark and metadata (see table 1 below) associated with this data set. Attaching this information (and its contents) to define policies and requirements for data set usage is part of the proposed technique. In the first example, the data authors may publish their work via Internet services like stackexchange.com or the like. In those cases, this Internet service may provide metadata for posts it maintains, for example. Adding a watermark may allow for easy proof that the data set was used to train machine learning model. If such watermark is added to the data set for example specific prompts may be executed against the trained model and the response will contain information proving that the concrete input data was used to train this model. This is also described in the scientific paper: Y. Li, M. Zhu, X. Yang, Y. Jiang, T. Wei and S.-T. Xia, “Black-Box Dataset Ownership Verification via Backdoor Watermarking,” in IEEE Transactions on Information Forensics and Security, vol. 18, pp. 2318-2332, 2023, doi: 10.1109/TIFS.2023.3265535. This technique may be used by the data set owner to check if specific machine learning model were trained using their data set. If machine learning model company cannot provide proof that they paid for this usage, then data set owner can sue the company and demand appropriate indemnity.

Further, a way of proving that the specific data set was used or was not used to train the model may be realized by a machine learning model “bill of materials” (BOM). In a setting where all the machine learning model training is executed in an attestable environment (such as a TEE), every model weight update may be accounted for and linked to (via hash tree/ledger) with inputs that contributed to it. Hence, being able to produce the BOM may be proof of model's full origin, including which data sets (hashes) were or were not used to train it. Metadata may not contain information about required payment and other requirements which may be fulfilled if the data set is going to be used by machine learning model company to train a machine learning model. The machine learning model company receives a certificate (“Proof of Payment”). For example, the machine learning model companies may follow instructions enclosed in the data set. If not, it will be easy to prove as described above that the model was trained using data set without fulfilling all requirements including payment because the company will not have any Proof of Payment.

Further, before publishing the data set, the owner may either store reference to this data set (in form of hash, for example) in the distributed ledger (for example using an NFT or any other cryptocurrency), and/or in Trusted Escrow/Verifier. In addition, attached metadata may be digitally signed by data set owner and public key shall be stored along with the reference. This is needed to prevent somebody else from claiming ownership of this data set.

Table 1 illustrates the metadata fields that may be available in the metadata The format (such as JSON) and syntax of the metadata may be standardized, so it may be processed fully automated:

TABLE 1
Metadata content

| Field | Description |
|---|---|
| Data Set | Hash of the data set used to uniquely identify it. This hash shall be |
| Reference | stored in the distributed ledger or kept by Trusted Escrow/Verifier. |
| Payment | Amount of money to pay by AI company to the data set owner |
| amount | |
| Currency | Currency, may be crypto currency |
| Payment | If traditional currency is used, then this is the bank account number |
| address | of the data set owner. If crypto currency is used, then this is data |
| | owner's crypto currency wallet address |
| Usage | A list of additional requirements or constraints in the form of |
| constraints | key = value tuples. Keys shall be predefined strings determining type |
| | of value. For example: |
| | Max_umber_of_ai_models_to train = 3, |
| | Can_be_used_for_military_purposes = false |

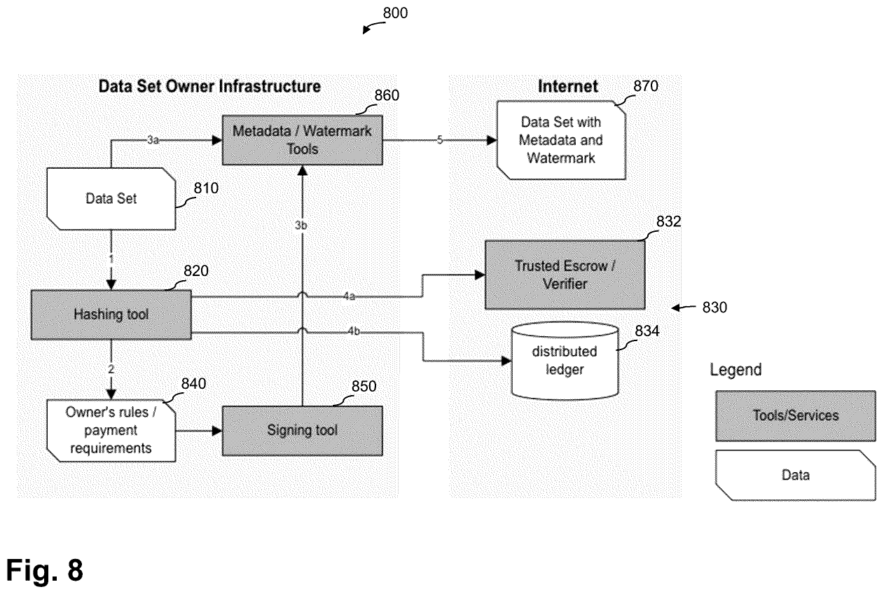

FIG. 8 illustrates a first example of the process of publishing data by a first entity (data set owner). In a first step the data set owner may use a hashing tool 820, which may be provided by the trusted third-party 830 (such as a trusted escrow and/or a verifier) to create unique reference to the data set 810. For example, the generated hash from the data set may be calculated and used as the reference. In a second step the generated reference may be appended to other requirements 840 (which may include payment information) prepared by data set owner. Then the metadata may be signed by a signing tool 850. In a third step the data set 810 is appended with the signed metadata 850 and/or the watermark is inserted and/or the metadata in encrypted into the watermark with the metadata/watermark tool 860. In a fourth step the generated data set reference is stored at the trusted third party 832 such as a trusted escrow/verifier 832 and/or a distributed ledger 834. In a fifth step the combined data set 870, that is the data set 810 along with watermarking and/or signed metadata is published on the Internet.

Once the combined data set 870 with the data set and the watermark and/or metadata is published on the Internet, the machine learning companies may follow the following procedure which fulfills the policies. After the machine learning company downloaded the data set it may follow the instructions included in the watermark and/or the metadata to avoid potential lawsuits. For example, the machine learning company may use a pre-approved TEE component ensuring compliance. In another example, a machine learning airlock component may be used. The machine learning airlock may be a mechanism within a TEE that actively verifies the integrity of both data and machine learning models before, during, and after the training process. It isolates the training environment and introduces controlled test data to detect malicious behavior, while monitoring system telemetry to identify anomalies. If all security checks are successful, the model is allowed to exit the airlock; otherwise, it is blocked or reset. This process ensures that only verified, tamper-free models and data are used, preventing unauthorized access, data leaks, and side-channel attacks throughout the training and deployment stages (this is also disclosed in the Intel patent application named “An Apparatus For Secure Machine Learning Model Training, A Method For Secure Machine Learning Model Training And A Non-Transitory Machine-Readable Storage Medium”, filed on Oct. 21, 2024, by the inventors Mateusz Bronk, Arkadiusz Berent, Piotr Zmijewski, Krystian Matusiewicz). It would mean that once the machine learning company downloads the data set, the watermark and/or metadata is examined to check if all usage conditions are met and to fulfill conditions which are not met (like payment to the data set owner, for example).

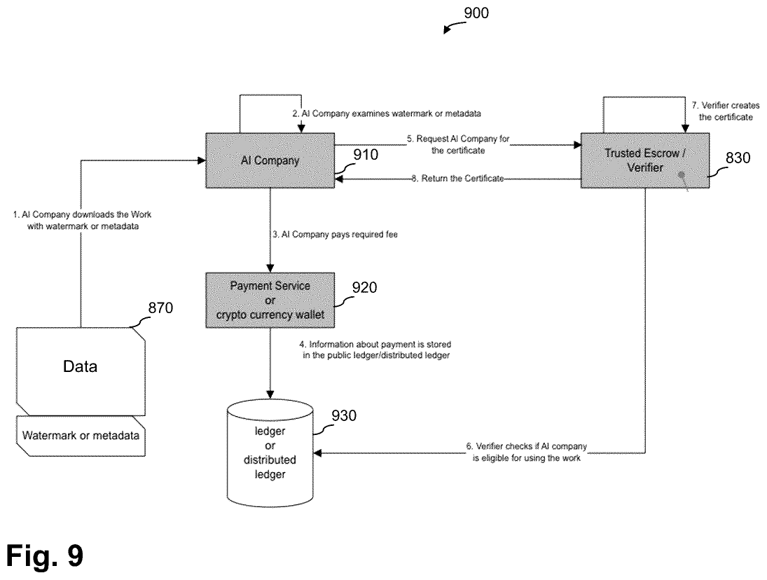

FIG. 9 illustrates a first example the process of obtaining published data by a second entity (machine learning model company). In a first step the machine learning model company 910 downloads the combined data set 870 from the Internet. The combined data set 870 contains watermark and/or metadata. In a second step the machine learning model company 910 may use a tool, for example provided by the trusted third-party 830 (such as a verifier), to check what are the requirements to be fulfilled to use the data set to train machine learning model. If the machine learning model company 910 examined that that one of the requirements is payment to the data set owner, in a third step, the machine learning model company 910 may contact the payment service and/or crypto currency wallet 920 to pay the required fee. In a fourth step, the payment service and/or crypto currency wallet 920 may store the information about the payment in a ledger and/or distributed ledger 930 depending on the service used for payments. In a fifth step, once the payment is made and recorded, the trusted third-party 830 (such as the trusted verifier) may receive a request for a certificate which is a proof of payment. In a sixth step the trusted third party 830 checks if the appropriate payment was made, for example by communicating with the payment service and/or crypto currency wallet 920. In a seventh step, if the checks from the sixth step pass, the trusted third-party may create the requested certificate, comprising the proof of payment. The certificate may further contain information about machine learning model company 920, the payment and declaration of the way data set will be used. In an eighth step, the certificate is returned to machine learning model company 920. From now on, the machine learning model company 920 may use it to prove that they fulfilled all requirements and are eligible to use data set to train their machine learning model.

In another example, instead or in addition to watermarking, the machine learning model company 920 may use a BOM built of all data sets used to be able to provide this information in case of any audit. The BOM and training may be done in attested TEE and signed by this TEE. This way it could be used as proof of what data was used.

For example, if the machine learning model company downloads the data set with requirements but decides not to fulfill any of requirements included in the watermark and/or the metadata, then if it is discovered that their machine learning model was trained on this data set using techniques described earlier, the company may be sued. Such lawsuits may become more common as data owners realize that machine learning model generate images similar to their work, or voice assistant sound similar to them. Resolving the case in court may end up with much higher costs than just fulfilling requirements provided by the data set owner. For example, techniques like as described in the scientific paper Sun, Zhensu, et al. “Coprotector: Protect open-source code against unauthorized training usage with data poisoning.” Proceedings of the ACM Web Conference 2022. 2022, or other may be used allowing executing specified prompts against the trained machine learning model, which reveals that owner's data set was used to train this model.

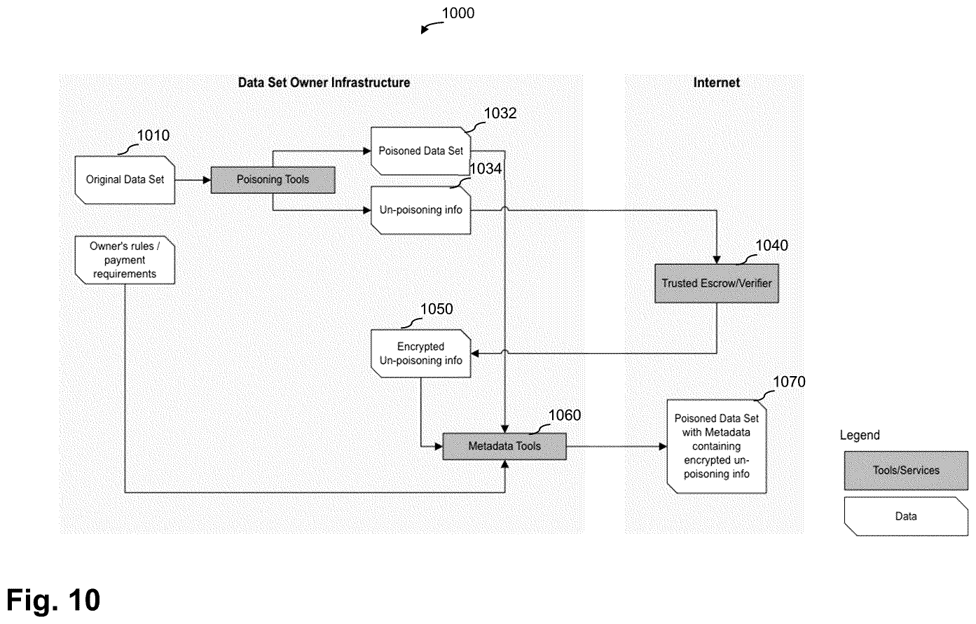

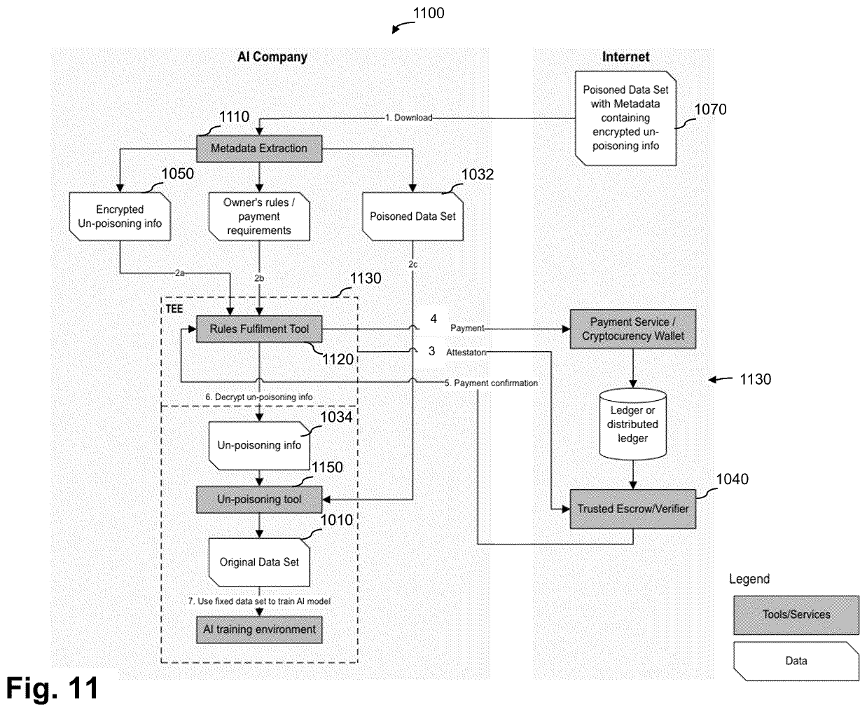

Further details and aspects are mentioned in connection with the examples described above or below. The example shown in FIGS. 8, 9 may include one or more optional additional features corresponding to one or more aspects mentioned in connection with the proposed concept or one or more examples described above (e.g., FIGS. 1-7) or below (e.g., FIGS. 10-11).

In a second example, the data may be poisoned. This technique may be applied to images and/or to video and audio content as described in the paper Shan, Shawn, et al. “Nightshade: Prompt-specific poisoning attacks on text-to-image generative models.” arXiv preprint arXiv:2310.13828 (2023). The technique may be also used with text-based data sets like source code as described in the paper Sun, Zhensu, et al. “Coprotector: Protect open-source code against unauthorized training usage with data poisoning.” Proceedings of the ACM Web Conference 2022. 2022. For example, the data set author modifies some portion of his data set (for example some pixels in the image) in the way it is not perceivable by humans, but may it significantly impact the quality of a trained machine learning model which was trained on such data set. This type of poisoning may be used for example by the tool Nightshade (see Shan, Shawn, et al. “Nightshade: Prompt-specific poisoning attacks on text-to-image generative models.” arXiv preprint arXiv:2310.13828 (2023)) to protect images. For example, Nightshade may protect images by poisoning them through adding some small changes to the pixels. Those changes are invisible to the human but can be disastrous to the model training process. The data set author may publish the poisoned data set, but the metadata contains instructions to un-poison or revert to the original data set with no disastrous modifications. This metadata format may be standardized to allow easy processing by the machine so the process can be automated. It may contain similar info to the metadata as described above but may be extended with information needed for un-poisoning. For example, table 2 illustrates the metadata fields that may be available in the metadata:

TABLE 2
Metadata content

| Field | Description |
|---|---|
| Data Set | Hash of the data set used to uniquely identify it. This hash shall be |
| Reference | stored in the distributed ledger or kept by Trusted Escrow/Verifier. |
| Payment | Amount of money to pay by machine learning model company to the |
| amount | data set owner |
| Currency | Currency, may be crypto currency |
| Payment | If traditional currency is used, then this is the bank account number |
| address | of the data set owner. If crypto currency is used, then this is data |
| | owner's crypto currency wallet address |
| Usage | A list of additional requirements or constraints in the form of |
| constraints | key = value tuples. Keys shall be predefined strings determining type |
| | of value. For example: |
| | Max_umber_of_ai_models_to train = 3, |
| | Can_be_used_for_military_purposes = false |
| Un- | This may be encrypted diff information needed to reconstruct the |
| poisoning | image, for example. It may contain a list of offsets to |
| information | modified/poisoned pixels along with original values before poisoning |
| | was applied. |

In some examples, poisoning and un-poisoning of the data may also be done multiple times on the same data set. Depending on the number of iterations, the resulting data set may be of different quality. For example, more poisoning iterations may create a poisoned data set of lower quality. The poisoned data set metadata may then contain encrypted reverse information to un-poison each iteration. Access to the number of un-poison iteration information may be dependent on the payment. If the machine learning model company wants to have original data set without any poisoned data in it, they would need to pay more to access the un-poison information for all poisoning iterations. If a lower quality data set is enough, the machine learning model company may decide to pay only for a subset of un-poison iterations.

FIG. 10 illustrates a second example of the process of publishing data by a first entity (data set owner). In a first step the data set owner may use a poisoning tool 1020 (which may be operated by the data set owner or by an external party) an input the original data 1010 into it. In a second step, the poisoning tool 1020 may generate poisoned data 1032 and the corresponding un-poisoning data 1034. In a third step un-poisoning data 1034 may be transmitted to the trusted third-party 1040 (for example a trusted escrow/verifier). In a fourth step the trusted third-party 1040 may generate the encrypted the un-poisoning data 1050 and store it. In a fifth step the trusted third-party 1040 may further transmit the encrypted the un-poisoning data 1050 to the metadata/watermark tool 1060. In a sixth step the metadata/watermark tool 860 may generate the combined data 1070, comprising the poisoned data set 1032 together with the metadata which comprises the encrypted the un-poisoning data 1050. In a seventh step the combined data set 1070 is published on the Internet.

Once the data combined set is published by the data set owner it may be used by the machine learning model company, but the company cannot use it if requirements specified by the data set owner are not met. This is because the data set in the form available to download from the Internet would cause the model trained using this data would be working incorrectly. The information about poisoning is included in the metadata attached to the data set. This way machine learning model company knows upfront that using this data set is pointless.

In order to be able to use the data set to train the machine learning model, the steps as described with regards to FIG. 11 may be carried out. FIG. 11 illustrates a second example of the process of obtaining published data by a second entity (machine learning model company). In step 1 the machine learning model company the combined data set 1070 from the internet, the combined data set 1070 comprising the poisoned data and the metadata. In a second step the machine learning model company operates a metadata extraction tool 1110 to check what are the requirements for using the data set, if any. For example, the at this stage the machine learning model company may learn that the data set is poisoned, and that they may not waste resources to use data set to train the machine learning model unless they fulfill requirements. Then the machine learning model company may forward the encrypted un-poisoning data 1050 and the requirements defined by the data set owner (both included in the metadata) into a rules fulfillment tool 1120, which makes sure that all requirements including payment are fulfilled (the fool may be operated by the machine learning model company). The rules fulfillment tool 1120 may be executed in TEE 1130 to protect all verification steps from rogue manipulation. For example, the when the requirements limit the number of usages of the data set for training machine learning model, the TEE 1130 may be extended all the way to protect the un-poisoning data 1050, the un-poisoning tools and the training environment. In some examples, all operations carried out by the TEE 1130 may be carried out by trusted third-party 1040 (such as the trusted escrow/verifier). In a third step, the TEE 1130 may be attested before any verification steps are started and before secrets used to decrypt un-poisoning data 1050 are provisioned from trusted third party 1040. In a fourth step the machine learning model company makes payment which is recorded by the payment service 1130 or in distributed ledger (for example for a cryptocurrency transaction). In a fifth step rules fulfilment tool 1120 may receive a confirmation from trusted third party 1040 that the payment was done. Further, a decryption key needed to decrypt the encrypted un-poisoning data 1050 may be returned. In a sixth step, the encrypted un-poisoning data 1050 is decrypted to obtain the decrypted un-poisoning data 1050. The decrypted un-poisoning data 1034 is used by an un-poisoning tool 1150 to generate the original data set 1010 or at least increase the quality of the poisoned data set (depending on whether full un-poison is performed or only a selective one) Then the data set can be used to train machine learning model since data set does not contain poisoned data anymore.

Further details and aspects are mentioned in connection with the examples described above. The example shown in FIGS. 10, 11 may include one or more optional additional features corresponding to one or more aspects mentioned in connection with the proposed concept or one or more examples described above (e.g., FIGS. 1-9).

In the following, some examples of the proposed technique are presented:

An example (e.g., example 1) relates to an apparatus comprising interface circuitry, machine-readable instructions and processing circuitry to execute the machine-readable instructions to obtain data from a first party, the data being configured for training of a machine learning model of a second party, generate metadata corresponding to the data, the metadata comprising an identifier of the data, publish the data appended with the corresponding metadata, and transmit the metadata for storage to a trusted third-party.

Another example (e.g., example 2) relates to a previous example (e.g., example 1) or to any other example, further comprising that the data is poisoned data.

Another example (e.g., example 3) relates to a previous example (e.g., example 2) or to any other example, further comprising that the processing circuitry is further to execute the machine-readable instructions to obtain un-poisoning data, the un-poisoning data being configured to at least partly un-poison the poisoned data.

Another example (e.g., example 4) relates to a previous example (e.g., example 3) or to any other example, further comprising that the processing circuitry is further to execute the machine-readable instructions to transmit the un-poisoning data to the trusted third-party, and receive encrypted un-poisoning data from trusted third-party.

Another example (e.g., example 5) relates to a previous example (e.g., one of the examples 1 to 4) or to any other example, further comprising that the processing circuitry is further to execute the machine-readable instructions to insert a watermark into the data.

Another example (e.g., example 6) relates to a previous example (e.g., one of the examples 1 to 5) or to any other example, further comprising that the processing circuitry is further to execute the machine-readable instructions to sign the metadata with a cryptographic key.

Another example (e.g., example 7) relates to a previous example (e.g., one of the examples 1 to 6) or to any other example, further comprising that the trusted third-party comprises at least one of the following a digital ledger, a distributed digital ledger, a trusted digital escrow.

Another example (e.g., example 8) relates to a previous example (e.g., one of the examples 1 to 7) or to any other example, further comprising that generating the identifier of the data comprises generating a hash of the data.

Another example (e.g., example 9) relates to a previous example (e.g., one of the examples 1 to 8) or to any other example, further comprising that the metadata comprises a usage requirement for data use and/or additional information delivered after the usage requirement is fulfilled.

Another example (e.g., example 10) relates to a previous example (e.g., one of the examples 1 to 9) or to any other example, further comprising that the metadata of the data further comprises at least one of the following a payment amount for using the data for training of the machine learning model, a payment address for the payment amount, a usage constraint for the data and encrypted un-poisoning data.

Another example (e.g., example 11) relates to a previous example (e.g., one of the examples 1 to 10) or to any other example, further comprising that the data being configured for training of the machine learning model is at least one of the following one or more images, one or more videos, one or more text files.

An example (e.g., example 12) relates to an apparatus comprising interface circuitry, machine-readable instructions and processing circuitry to execute the machine-readable instructions to obtain data from a first party with appended metadata, the data being configured for training of a machine learning model of a second party, wherein the metadata comprises information about a usage requirement of the data, examine the metadata for the usage requirement of the data, perform an action to fulfill the usage requirement, and receive a certificate from a trusted third-party, the certificate comprising information about the fulfilled usage requirement.

Another example (e.g., example 13) relates to a previous example (e.g., example 12) or to any other example, further comprising that the usage requirement of the data comprises paying a required payment amount for using the data for training of the machine learning model to a payment address.

Another example (e.g., example 14) relates to a previous example (e.g., one of the examples 12 to 13) or to any other example, further comprising that the processing circuitry is further to execute the machine-readable instructions to generate a log during training of the machine learning model, the log comprising entries about data used in the training process and the log comprising an entry about the data, prove the fulfillment of the usage requirement based on generated log.

Another example (e.g., example 15) relates to a previous example (e.g., example 14) or to any other example, further comprising that the processing circuitry is further to execute the machine-readable instructions to generate a hash structure based on the log, the hash structure comprising linked cryptographic hashes, the linked cryptographic hashes being based on the entries of the log.

Another example (e.g., example 16) relates to a previous example (e.g., one of the examples 12 to 15) or to any other example, further comprising that the processing circuitry is further to execute the machine-readable instructions to prove the fulfillment of the usage requirement based on the certificate.

Another example (e.g., example 17) relates to a previous example (e.g., one of the examples 12 to 16) or to any other example, further comprising that the metadata further comprises at least one of the following a payment amount for using the data for training of the machine learning model, a payment address for the payment amount, a usage constraint for the data and encrypted un-poisoning data.

Another example (e.g., example 18) relates to a previous example (e.g., one of the examples 12 to 17) or to any other example, further comprising that the data is poisoned data, and the metadata further comprises encrypted un-poisoning data.

Another example (e.g., example 19) relates to a previous example (e.g., example 18) or to any other example, further comprising that the processing circuitry is further to execute the machine-readable instructions to decrypt the encrypted un-poisoning data, at least partly un-poison the poisoned data based on the decrypted un-poisoning data.

Another example (e.g., example 20) relates to a previous example (e.g., one of the examples 12 to 19) or to any other example, further comprising that the processing circuitry is further to execute the machine-readable instructions to instantiate a trusted execution environment and attest the integrity of the trusted execution environment to the trusted third-party.

Another example (e.g., example 21) relates to a previous example (e.g., example 20) or to any other example, further comprising that the trusted execution environment is a TDX trusted domain or a SGX enclave.

Another example (e.g., example 22) relates to a previous example (e.g., one of the examples 12 to 21) or to any other example, further comprising that the processing circuitry is further to execute the machine-readable instructions to train the machine learning model based on the data.

An example (e.g., example 23) relates to an apparatus comprising interface circuitry, machine-readable instructions and processing circuitry to execute the machine-readable instructions to store metadata corresponding to data of a first party, the data being configured for training of a machine learning model of a second party, wherein the metadata comprises an identifier of the data, receive a request for a certificate from a requestor, the certificate comprising evidence that a usage requirement of the data is fulfilled, evaluate if the usage requirement of the data is fulfilled, and transmit the certificate to the requestor, if the usage requirement of the data is fulfilled.

Another example (e.g., example 24) relates to a previous example (e.g., example 23) or to any other example, further comprising that evaluating if the usage requirement is fulfilled comprises making a request to an external system.

Another example (e.g., example 25) relates to a previous example (e.g., example 24) or to any other example, further comprising that the processing circuitry is further to execute the machine-readable instructions to receive evidence from the external system that the usage requirement is fulfilled.

Another example (e.g., example 26) relates to a previous example (e.g., one of the examples 23 to 25) or to any other example, further comprising that the processing circuitry is further to execute the machine-readable instructions to receive un-poisoning data, the un-poisoning data being configured to at least partly un-poison the poisoned data, encrypt the un-poisoning data.

Another example (e.g., example 27) relates to a previous example (e.g., example 26) or to any other example, further comprising that the processing circuitry is further to execute the machine-readable instructions to transmit the encrypted un-poisoning data to the transmitter of the un-poisoning data and/or include the encrypted un-poisoning data into the stored metadata corresponding to the data.

Another example (e.g., example 28) relates to a previous example (e.g., example 27) or to any other example, further comprising that the certificate further comprises a decryption key to decrypt the encrypted un-poisoning data and/or the decrypted un-poisoning data.

An example (e.g., example 29) relates to a method comprising obtaining data from a first party, the data being configured for training of a machine learning model of a second party, generating metadata corresponding to the data, the metadata comprising an identifier of the data, publishing the data appended with the corresponding metadata, and transmitting the metadata for storage to a trusted third-party.

Another example (e.g., example 30) relates to a previous example (e.g., example 29) or to any other example, further comprising that the data is poisoned data.

Another example (e.g., example 31) relates to a previous example (e.g., example 30) or to any other example, further comprising obtaining un-poisoning data, the un-poisoning data being configured to at least partly un-poison the poisoned data.

Another example (e.g., example 32) relates to a previous example (e.g., example 31) or to any other example, further comprising transmitting the un-poisoning data to the trusted third-party, and receiving encrypted un-poisoning data from trusted third-party.

Another example (e.g., example 33) relates to a previous example (e.g., one of the examples 29 to 32) or to any other example, further comprising inserting a watermark into the data.

Another example (e.g., example 34) relates to a previous example (e.g., one of the examples 29 to 33) or to any other example, further comprising signing the metadata with a cryptographic key.

Another example (e.g., example 35) relates to a previous example (e.g., one of the examples 29 to 34) or to any other example, further comprising that the trusted third-party comprises at least one of the following a digital ledger, a distributed digital ledger, a trusted digital escrow.

Another example (e.g., example 36) relates to a previous example (e.g., one of the examples 29 to 35) or to any other example, further comprising that generating the identifier of the data comprises generating a hash of the data.

Another example (e.g., example 37) relates to a previous example (e.g., one of the examples 29 to 36) or to any other example, further comprising that the metadata comprises a usage requirement for data use and/or additional information delivered after the usage requirement is fulfilled.

Another example (e.g., example 38) relates to a previous example (e.g., one of the examples 29 to 37) or to any other example, further comprising that the metadata of the data further comprises at least one of the following a payment amount for using the data for training of the machine learning model, a payment address for the payment amount, a usage constraint for the data and encrypted un-poisoning data.

Another example (e.g., example 39) relates to a previous example (e.g., one of the examples 29 to 38) or to any other example, further comprising that the data being configured for training of the machine learning model is at least one of the following one or more images, one or more videos, one or more text files.

An example (e.g., example 40) relates to a method comprising obtaining data with appended metadata, the data being configured for training of a machine learning model, wherein the metadata comprises information about a usage requirement of the data, examining the metadata for the usage requirement of the data, performing an action to fulfill the usage requirement, receiving a certificate from a third-party, the certificate comprising information about the fulfilled usage requirement.

Another example (e.g., example 41) relates to a previous example (e.g., example 40) or to any other example, further comprising that the usage requirement of the data comprises paying a required payment amount for using the data for training of the machine learning model to a payment address.

Another example (e.g., example 42) relates to a previous example (e.g., one of the examples 40 to 41) or to any other example, further comprising generating a log during training of the machine learning model, the log comprising entries about data used in the training process and the log comprising an entry about the data, proving the fulfillment of the usage requirement based on generated log.

Another example (e.g., example 43) relates to a previous example (e.g., example 42) or to any other example, further comprising generating a hash structure based on the log, the hash structure comprising linked cryptographic hashes, the linked cryptographic hashes being based on the entries of the log.

Another example (e.g., example 44) relates to a previous example (e.g., one of the examples 40 to 43) or to any other example, further comprising proving the fulfillment of the usage requirement based on the certificate.

Another example (e.g., example 45) relates to a previous example (e.g., one of the examples 40 to 44) or to any other example, further comprising that the metadata further comprises at least one of the following a payment amount for using the data for training of the machine learning model, a payment address for the payment amount, a usage constraint for the data and encrypted un-poisoning data.

Another example (e.g., example 46) relates to a previous example (e.g., one of the examples 40 to 45) or to any other example, further comprising that the data is poisoned data, and the metadata further comprises encrypted un-poisoning data.

Another example (e.g., example 47) relates to a previous example (e.g., example 46) or to any other example, further comprising decrypting the encrypted un-poisoning data, at least partly un-poisoning the poisoned data based on the decrypted un-poisoning data.

Another example (e.g., example 48) relates to a previous example (e.g., one of the examples 40 to 47) or to any other example, further comprising instantiating a trusted execution environment, and attesting the integrity of the trusted execution environment to the trusted third-party.

Another example (e.g., example 49) relates to a previous example (e.g., example 48) or to any other example, further comprising that the trusted execution environment is a TDX trusted domain or a SGX enclave.

Another example (e.g., example 50) relates to a previous example (e.g., one of the examples 40 to 49) or to any other example, further comprising training the machine learning model based on the data.

An example (e.g., example 51) relates to a method comprising storing metadata corresponding to data, the data being configured for training of a machine learning model, wherein the metadata comprises an identifier of the data, receiving a request for a certificate, the certificate comprising evidence that a usage requirement of the data is fulfilled, evaluating if usage requirement of the data is fulfilled, and transmitting the certificate to the requestor, if the usage requirement of the data is fulfilled.

Another example (e.g., example 52) relates to a previous example (e.g., example 51) or to any other example, further comprising that evaluating if the usage requirement is fulfilled comprises making a request to an external system.

Another example (e.g., example 53) relates to a previous example (e.g., example 52) or to any other example, further comprising receiving evidence from the external system that the usage requirement is fulfilled.

Another example (e.g., example 54) relates to a previous example (e.g., example 53) or to any other example, further comprising that the external system is a payment service.

Another example (e.g., example 55) relates to a previous example (e.g., one of the examples 51 to 54) or to any other example, further comprising receiving un-poisoning data, the un-poisoning data being configured to at least partly un-poison the poisoned data, encrypting the un-poisoning data.

Another example (e.g., example 56) relates to a previous example (e.g., example 55) or to any other example, further comprising transmitting the encrypted un-poisoning data to the transmitter of the un-poisoning data and/or including the encrypted un-poisoning data into the stored metadata corresponding to the data.

Another example (e.g., example 57) relates to a previous example (e.g., example 56) or to any other example, further comprising that the certificate further comprises a decryption key to decrypt the encrypted un-poisoning data and/or the decrypted un-poisoning data.

An example (e.g., example 58) relates to an apparatus comprising a processor circuitry configured to obtain data from a first party, the data being configured for training of a machine learning model of a second party, generate metadata corresponding to the data, the metadata comprising an identifier of the data, publish the data appended with the corresponding metadata, and transmit the metadata for storage to a trusted third-party

An example (e.g., example 59) relates to an apparatus comprising a processor circuitry configured to obtain data from a first party with appended metadata, the data being configured for training of a machine learning model of a second party, wherein the metadata comprises information about a usage requirement of the data, examine the metadata for the usage requirement of the data, perform an action to fulfill the usage requirement, and receive a certificate from a trusted third-party, the certificate comprising information about the fulfilled usage requirement.

An example (e.g., example 60) relates to an apparatus comprising a processor circuitry configured to store metadata corresponding to data of a first party, the data being configured for training of a machine learning model of a second party, wherein the metadata comprises an identifier of the data, receive a request for a certificate from a requestor, the certificate comprising evidence that a usage requirement of the data is fulfilled, evaluate if the usage requirement of the data is fulfilled, and transmit the certificate to the requestor, if the usage requirement of the data is fulfilled.

An example (e.g., example 61) relates to a device comprising means for processing for obtaining data from a first party, the data being configured for training of a machine learning model of a second party, generating metadata corresponding to the data, the metadata comprising an identifier of the data, publishing the data appended with the corresponding metadata, and transmitting the metadata for storage to a trusted third-party.

An example (e.g., example 62) relates to a device comprising means for processing for obtaining data with appended metadata, the data being configured for training of a machine learning model, wherein the metadata comprises information about a usage requirement of the data, examining the metadata for the usage requirement of the data, performing an action to fulfill the usage requirement, receiving a certificate from a third-party, the certificate comprising information about the fulfilled usage requirement

An example (e.g., example 63) relates to a device comprising means for processing for storing metadata corresponding to data, the data being configured for training of a machine learning model, wherein the metadata comprises an identifier of the data, receiving a request for a certificate, the certificate comprising evidence that a usage requirement of the data is fulfilled, evaluating if usage requirement of the data is fulfilled, and transmitting the certificate to the requestor, if the usage requirement of the data is fulfilled.

Another example (e.g., example 64) relates to a non-transitory machine-readable storage medium including program code, when executed, to cause a machine to perform the method of any one of the examples 29 to 39, 40 to 50 and/or 51 to 57.

Another example (e.g., example 65) relates to a computer program having a program code for performing the method of any one of the examples 29 to 39, 40 to 50 and/or 51 to 57 when the computer program is executed on a computer, a processor, or a programmable hardware component.

Another example (e.g., example 66) relates to a machine-readable storage including machine readable instructions, when executed, to implement a method or realize an apparatus as claimed in any pending claim.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim. of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus comprising interface circuitry, machine-readable instructions and processing circuitry to execute the machine-readable instructions to:
obtain data from a first party, the data being configured for training of a machine learning model of a second party;
generate metadata corresponding to the data, the metadata comprising an identifier of the data;
publish the data appended with the corresponding metadata; and
transmit the metadata for storage to a trusted third-party.

2. The apparatus of claim 1, wherein the data is poisoned data.

3. The apparatus of claim 2, wherein the processing circuitry is further to execute the machine-readable instructions to obtain un-poisoning data, the un-poisoning data being configured to at least partly un-poison the poisoned data.

4. The apparatus of claim 3, wherein the processing circuitry is further to execute the machine-readable instructions to transmit the un-poisoning data to the trusted third-party; and
receive encrypted un-poisoning data from trusted third-party.

5. The apparatus of claim 1, wherein the processing circuitry is further to execute the machine-readable instructions to insert a watermark into the data.

6. The apparatus of claim 1, wherein the processing circuitry is further to execute the machine-readable instructions to sign the metadata with a cryptographic key.

7. The apparatus of claim 1, wherein the trusted third-party comprises at least one of the following: a digital ledger, a distributed digital ledger, a trusted digital escrow.

8. The apparatus of claim 1, wherein generating the identifier of the data comprises generating a hash of the data.

9. The apparatus of claim 1, wherein the metadata comprises a usage requirement for data use and/or additional information delivered after the usage requirement is fulfilled.

10. The apparatus of claim 1, wherein the metadata of the data further comprises at least one of the following: a payment amount for using the data for training of the machine learning model, a payment address for the payment amount, a usage constraint for the data and encrypted un-poisoning data.

11. The apparatus of claim 1, wherein the data being configured for training of the machine learning model is at least one of the following: one or more images, one or more videos, one or more text files.

12. An apparatus comprising interface circuitry, machine-readable instructions and processing circuitry to execute the machine-readable instructions to:
obtain data from a first party with appended metadata, the data being configured for training of a machine learning model of a second party, wherein the metadata comprises information about a usage requirement of the data;
examine the metadata for the usage requirement of the data;
perform an action to fulfill the usage requirement; and
receive a certificate from a trusted third-party, the certificate comprising information about the fulfilled usage requirement.

13. The apparatus of claim 12, wherein the usage requirement of the data comprises paying a required payment amount for using the data for training of the machine learning model to a payment address.

14. The apparatus of claim 12, wherein the processing circuitry is further to execute the machine-readable instructions to:
generate a log during training of the machine learning model, the log comprising entries about data used in the training process and the log comprising an entry about the data;
prove the fulfillment of the usage requirement based on generated log.

15. The apparatus of claim 14, wherein the processing circuitry is further to execute the machine-readable instructions to generate a hash structure based on the log, the hash structure comprising linked cryptographic hashes, the linked cryptographic hashes being based on the entries of the log.

16. The apparatus of claim 12, wherein the processing circuitry is further to execute the machine-readable instructions to prove the fulfillment of the usage requirement based on the certificate.

17. The apparatus of claim 12, wherein the metadata further comprises at least one of the following: a payment amount for using the data for training of the machine learning model, a payment address for the payment amount, a usage constraint for the data and encrypted un-poisoning data.

18. The apparatus of claim 12, wherein the data is poisoned data, and the metadata further comprises encrypted un-poisoning data.

19. The apparatus of claim 12, wherein the processing circuitry is further to execute the machine-readable instructions to:
instantiate a trusted execution environment; and
attest the integrity of the trusted execution environment to the trusted third-party.

20. An apparatus comprising interface circuitry, machine-readable instructions and processing circuitry to execute the machine-readable instructions to:
store metadata corresponding to data of a first party, the data being configured for training of a machine learning model of a second party, wherein the metadata comprises an identifier of the data;
receive a request for a certificate from a requestor, the certificate comprising evidence that a usage requirement of the data is fulfilled;
evaluate if the usage requirement of the data is fulfilled; and
transmit the certificate to the requestor, if the usage requirement of the data is fulfilled.
